(19) United States
(12) Patent Application Publication
(10) Pub. No.: US 2015/0127325 A1
(43) Pub. Date: May 7, 2015

(54) METHODS AND SYSTEMS FOR NATURAL LANGUAGE COMPOSITION CORRECTION

(71) Applicant: NetaRose Corporation, Cambridge, MA (US)

(72) Inventors: Martha Birnbaum, Cambridge, MA (US); Marian Macchi, Princeton, NJ (US); Peter L. Alcivar, Palm Harbor, FL (US)

(21) Appl. No.: 14/535,624

(22) Filed: Nov. 7, 2014

Related U.S. Application Data
(60) Provisional application No. 61/901,222, filed on Nov. 7, 2013.

(51) Int. Cl. G06F 17/27; G06F 17/28

(52) U.S. Cl. CPC G06F 17/274; G06F 17/28
USPC 704/9

(57) ABSTRACT

The present disclosure relates to methods and systems for improving the probability of detection of grammatical errors. In one aspect, a method for improving probability of detection of grammatical errors is based on one or more linguistic algorithms that relies on demographic information of the writer. Examples of types of demographic information that may be used to improve the probability of detection of grammatical errors includes a native language of the speaker, a country of origin of the writer, the writer's age, gender, amongst others. In another aspect, methods and systems for evaluating a user's level of competence in a natural language are provided. According to yet another aspect, methods and systems for detecting grammatical errors using a set of error detection rules are provided.

### RELATED APPLICATION

This application claims the benefit of and priority to U.S. Provisional Application No. 61/901,222, entitled “METHODS AND SYSTEMS FOR NATURAL LANGUAGE COMPOSITION CORRECTION” and filed on Nov. 7, 2013, which is incorporated herein by reference in their entirety for all purposes.

### FIELD OF THE DISCLOSURE

The present application relates generally to natural language composition correction, more particularly, to improved methods and systems for identifying and correcting grammatical errors occurring in a natural language composition.

### DESCRIPTION OF THE RELATED TECHNOLOGY

Nearly every natural language, including English, relies on grammatical rules to impose structure on the natural language. In many situations, the correct application of grammatical rules of a natural language is important and expected. In particular, the correct usage of a natural language in a written document, such as a resume, a marketing pitch, a presentation or a legal document, is sometimes used by a reader of the document to gauge the credibility of the document or the writer of the document. Due to the expectations of readers, writers oftentimes will utilize computerized grammar tools to check their documents for grammatical issues. Such grammar tools can aid writers in conforming documents to the grammatical rules of natural languages.

### SUMMARY

According to one aspect, methods and systems for improving the probability of detection of grammatical errors are provided. In particular, a method for improving probability of detection of grammatical errors is based on one or more linguistic algorithms that rely on demographic information of the writer. Examples of types of demographic information that may be used to improve the probability of detection of grammatical errors include the native language of the speaker, the country of origin of the writer, the writer's age, gender, amongst others. In another aspect, methods and systems for evaluating a user's level of competency in a natural language are provided. In particular, a method to quantify a writer's level of competency in a natural language can include implementing a weighting scheme based on the number and types of grammatical errors the writer makes. In some implementations, the method includes identifying and analyzing the grammatical errors in the writer's writing. In particular, the method can determine the type of grammatical error for each identified error and identify a frequency of each type of grammatical error. The method can include computing a competency score based in part on the frequency of each type of grammatical error made by the writer. In some implementations, the method further includes identifying one or more reasons justifying the competency score and providing one or more suggestions to help improve the competency score of the writer.

According to yet another aspect, methods and systems for detecting grammatical errors using a set of error detection rules are provided. In particular, the method can detect grammatical errors by executing a computer-implemented algorithm that includes one or more error detection rules. The method can detect an error by analyzing a sequence of two or more words, identifying characteristics of the words and determining that the sequence of words based on the identified characteristics of the words match a predefined error rule.

According to yet another aspect, a method for detecting grammatical errors in a sequence of words using a set of error detection rules is described. A grammatical checker configured on a device including one or more processors identifies word data representing a sequence of words to be analyzed for grammatical errors. The grammatical checker determines that each of the sequence of words matches a word in a corpus represented by corpus data stored on the device. A third-party tagging system configured on the device assigns one or more third-party tags to each of the words of the sequence of words. The device stores, for each of the words, the one or more third-party tags assigned to the word with the word. The grammatical checker compares one or more of the words of the sequence of words to a predetermined list of words to be tagged using custom tags instead of third-party tags. The grammatical checker identifies, based on the comparison, a word of the sequence of words that is included in the predetermined list of words. A first tagging system configured on the device assigns a custom tag to the identified word. The device stores the custom tag with the identified word and removes the third-party tags assigned to the identified word. The grammatical checker generates a first sequence of tags including the custom tag and the one or more third-party tags. The sequence of tags is arranged in the order of the words in the sequence of words. The grammatical checker identifies an error-based rule that specifies a second sequence of tags representative of a grammatical error and corresponding third sequence of tags representative of a correction of the grammatical error of the second sequence of tags. The device stores the second sequence of tags and the third sequence of tags. The grammatical checker determines that the first sequence of tags matches the second sequence of tags of the error-based rule. Responsive to determining that the first sequence of tags matches the second sequence of tags of the error-based rule, a grammatical corrector configured on the device adjusts the sequence of words to a revised sequence of words such that a revised sequence of tags based on the revised sequence of words matches the third sequence of tags. The device then provides, for display, the revised sequence of words.

In some implementations, identifying the word data representing a sequence of words to be analyzed for grammatical errors includes receiving a document including the sequence of words to be analyzed for grammatical errors.

In some implementations, the grammatical checker determines that a misspelt word of the sequence of words does not match any word in the corpus. The grammatical checker determines, based on comparing characters of the misspelt word, that the misspelt word is similar to one or more words of the corpus. The grammatical checker identifies tags associated with each of the one or more words of the corpus to which the misspelt word is similar. The first tagging system assigns the misspelt word a custom tag indicating that the word is misspelt and assigns the misspelt word one or more tags based on the words of the corpus to which the misspelt word is similar. In some implementations, the custom tags assigned to the word that is included in the predetermined list of words is based on a combination of a part-of-speech tag, a singular or plural tag and a tense tag.

In some implementations, adjusting the sequence of words to a revised sequence of words includes identifying, based on a comparison of the first sequence of tags and the third sequence of tags, a subset of tags of the first sequence of tags that are different from a corresponding subset of the third sequence of tags. The grammatical checker identifies a subset of words of the sequence of words corresponding to the subset of tags. The grammar corrector replaces the subset of words with a revised subset of words from the corpus that when assigned tags, match the subset of the third sequence of tags. In some implementations, replacing the subset of words with a revised subset of words includes identifying the tags of the subset of the third sequence of tags and identifying, from the corpus, words corresponding to the tags of the subset of the third sequence of tags as the revised subset of words.

In some implementations, the device can identify one or more characteristics of a writer of the sequence of words. The device can determine, based on the characteristics of the writer, an order in which the grammar corrector applies one or more of a plurality of error-based rules to determine if the sequence of words includes a grammatical error. The device can then apply the plurality of error-based rules based on the determined order. In some implementations, the characteristics of the writer of the sequence of words includes a geographic region to which the writer belongs. In some implementations, the device can determine the characteristics of the writer by analyzing the sequence of words.

In some implementations, the device can compute a score indicating a level of proficiency of a document in which the sequence of words are included based on a quantity of different error-based rules that matched the sequence of words and provide the computed score for display.

According to yet another aspect, a system for detecting grammatical errors in a sequence of words using a set of error detection rules is described. The system includes a grammar corrector having a memory and one or more processors. The grammar corrector is configured to identify, by a grammatical checker configured on grammar corrector, word data representing a sequence of words to be analyzed for grammatical errors. The grammar corrector is configured to determine, by the grammatical checker, that each of the sequence of words matches a word in a corpus represented by corpus data stored on the memory. The grammar corrector is configured to assign, by a third-party tagging system configured on the grammar corrector, one or more third-party tags to each of the words of the sequence of words. The grammar corrector stores, for each of the words, the one or more third-party tags assigned to the word with the word. The grammar corrector is configured to compare, by the grammatical checker, one or more of the words of the sequence of words to a predetermined list of words to be tagged using custom tags instead of third-party tags. The grammar corrector is configured to identify, by the grammatical checker, based on the comparison, a word of the sequence of words that is included in the predetermined list of words. The grammar corrector is configured to assign, by a first tagging system configured on the grammar corrector, a custom tag to the identified word. The grammar corrector stores the custom tag with the identified word. The grammar corrector is configured to generate, by the grammatical checker, a first sequence of tags including the custom tag and the one or more third-party tags, the sequence of tags arranged in the order of the words in the sequence of words. The grammar corrector is configured to identify, by the grammatical checker, an error-based rule that specifies a second sequence of tags representative of a grammatical error and corresponding third sequence of tags representative of a correction of the grammatical error of the second sequence of tags. The grammar corrector stores the second sequence of tags and the third sequence of tags. The grammar corrector is configured to determine, by the grammatical checker, that the first sequence of tags matches the second sequence of tags of the error-based rule. The grammar corrector is configured to responsive to determining that the first sequence of tags matches the second sequence of tags of the error-based rule, adjust the sequence of words to a revised sequence of words such that a revised sequence of tags based on the revised sequence of words matches the third sequence of tags. The grammar corrector is configured to provide, for display, the revised sequence of words.

In some implementations, the grammar corrector receives a document including the sequence of words to be analyzed for grammatical errors. In some implementations, the grammar corrector is further configured to determine, by the grammatical checker, that a misspelt word of the sequence of words does not match any word in the corpus. The grammar corrector is configured to determine, based on comparing characters of the misspelt word, that the misspelt word is similar to one or more words of the corpus. The grammar corrector is configured to identify tags associated with each of the one or more words of the corpus to which the misspelt word is similar. The grammar corrector is configured to assign the misspelt word a custom tag indicating that the word is misspelt and assign the misspelt word one or more tags based on the words of the corpus to which the misspelt word is similar.

In some implementations, the custom tags assigned to the word that is included in the predetermined list of words are based on a combination of a part-of-speech tag, a singular or plural tag and a tense tag.

In some implementations, the grammar corrector is further configured to identify, based on a comparison of the first sequence of tags and the third sequence of tags, a subset of tags of the first sequence of tags that are different from a corresponding subset of the third sequence of tags. The grammar corrector is configured to identify a subset of words of the sequence of words corresponding to the subset of tags. The grammar corrector is configured to replace the subset of words with a revised subset of words from the corpus that when assigned tags, match the subset of the third sequence of tags.

In some implementations, replacing the subset of words with a revised subset of words includes identifying the tags of the subset of the third sequence of tags and identifying, from the corpus, words corresponding to the tags of the subset of the third sequence of tags as the revised subset of words.

In some implementations, the grammar corrector is further configured to identify one or more characteristics of a writer of the sequence of words. The grammar corrector is configured to determine, based on the characteristics of the writer, an order in which the grammar corrector applies one or more of a plurality of error-based rules to determine if the sequence of words includes a grammatical error and apply the plurality of error-based rules based on the determined order. In some implementations, the characteristics of the writer of the sequence of words include a geographic region to which the writer belongs. In some implementations, the grammar corrector determines the characteristics of the writer by analyzing the sequence of words.

In some implementations, the grammar corrector is further configured to compute a score indicating a level of proficiency of a document in which the sequence of words are included based on a quantity of different error-based rules that matched the sequence of words and provide the computed score for display.

### BRIEF DESCRIPTION OF THE DRAWINGS

FIG. 1A is a block diagram depicting an embodiment of a network environment comprising local devices in communication with remote devices.

FIGS. 1B-1D are block diagrams depicting embodiments of computers useful in connection with the methods and systems described herein.

FIG. 2A is a block diagram illustrating a computer networked environment for improving the probability of grammatical error detection in accordance with various embodiments.

FIG. 2B is a block diagram of an embodiment of a grammar correction system for detecting and correcting grammatical errors.

FIGS. 3A-3E are a sequence of screenshots of a user interface through which users can submit written text and view identified grammatical errors and corrections in accordance with one or more embodiments.

FIG. 4 is a block diagram illustrating a flow of a method for improving the probability of grammatical error detection.

FIG. 5 is a block diagram illustrating a flow of a method for detecting grammatical errors in a sequence of words using a set of error detection rules.

FIGS. 6A-6E are a sequence of screenshots of a user interface through which users can submit written text and view identified grammatical errors and corrections in accordance with one or more embodiments.

### DETAILED DESCRIPTION

For purposes of reading the description of the various embodiments below, the following descriptions of the sections of the specification and their respective contents may be helpful:

Section A describes a network environment and computing environment which may be useful for practicing embodiments described herein.

Section B describes embodiments of systems and methods for improving the probability of grammatical error detection in accordance with various embodiments.

Section C describes embodiments of systems and methods for evaluating a writer's level of competence in a natural language.

### A. Computing and Network Environment

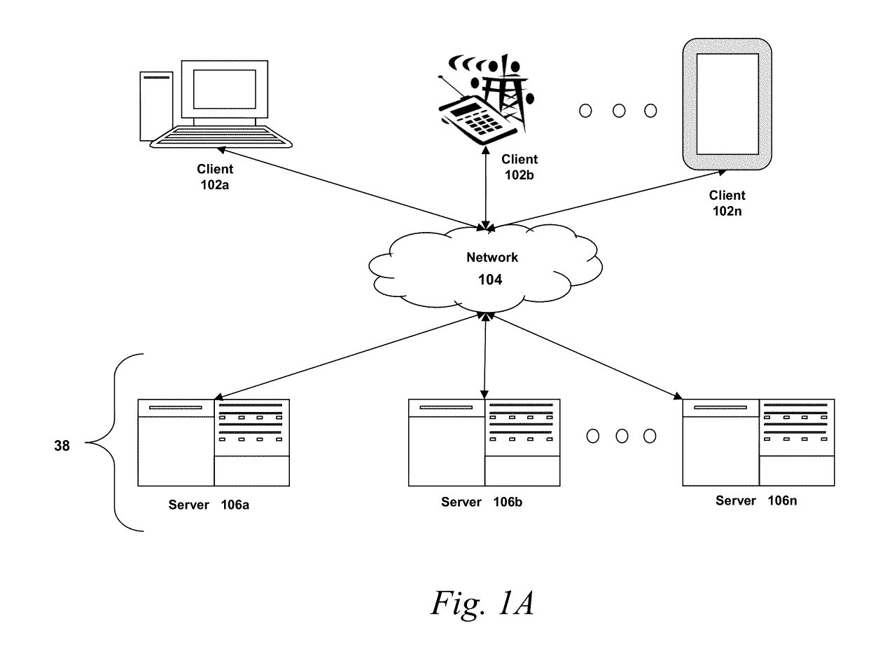

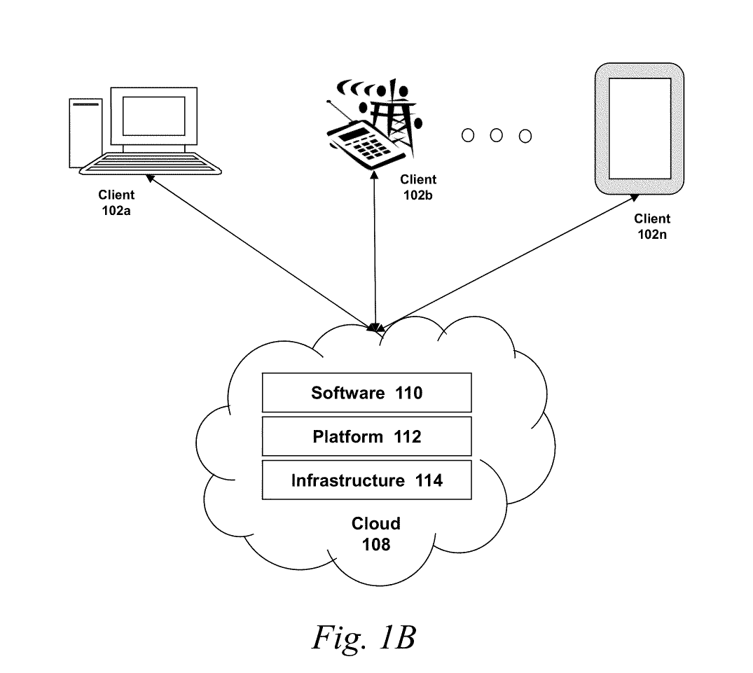

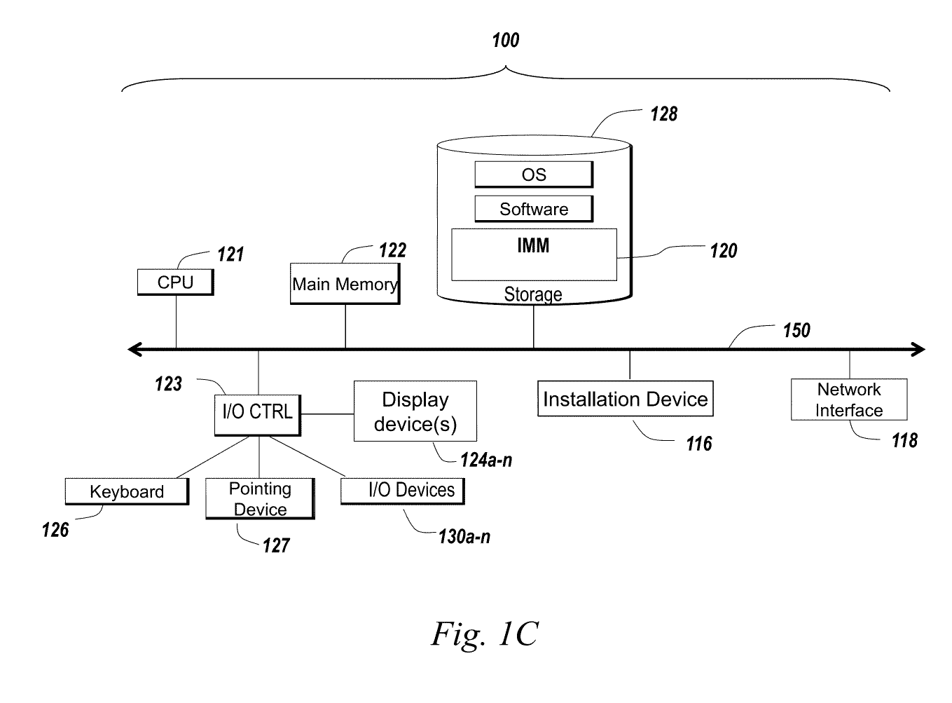

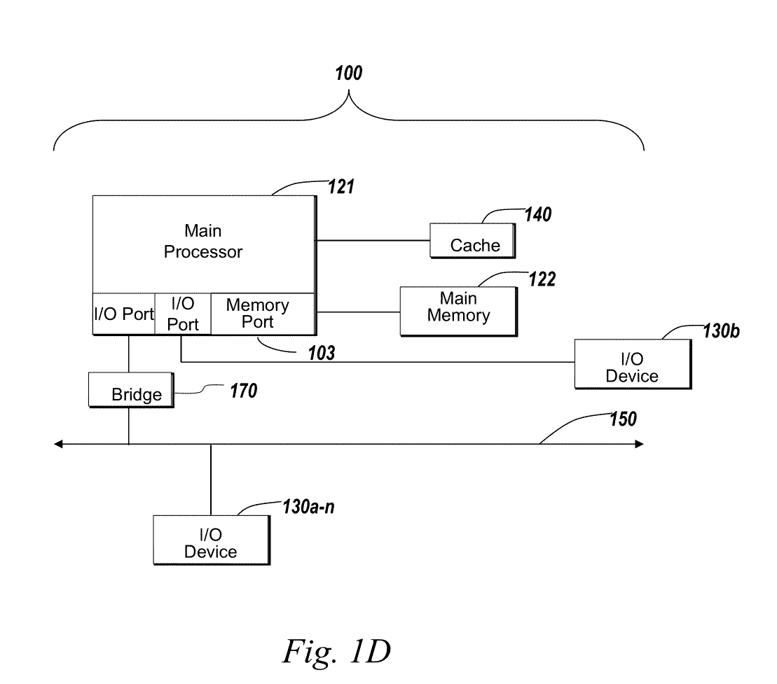

Prior to discussing specific embodiments of the present solution, it may be helpful to describe aspects of the operating environment as well as associated system components (e.g., hardware elements) in connection with the methods and systems described herein. Referring to FIG. 1A, an embodiment of a network environment is depicted. In brief overview, the network environment includes one or more clients 102a-102n (also generally referred to as local machine(s) 102, client(s) 102, client node(s) 102, client machine(s) 102, client computer(s) 102, client device(s) 102, endpoint(s) 102, or endpoint node(s) 102) in communication with one or more servers 106a-106n (also generally referred to as server(s) 106, node 106, or remote machine(s) 106) via one or more networks 104. In some embodiments, a client 102 has the capacity to function as both a client node seeking access to resources provided by a server and as a server providing access to hosted resources for other clients 102a-102n.

Although FIG. 1A shows a network 104 between the clients 102 and the servers 106, the clients 102 and the servers 106 may be on the same network 104. In some embodiments, there are multiple networks 104 between the clients 102 and the servers 106. In one of these embodiments, a network 104′ (not shown) may be a private network and a network 104 may be a public network. In another of these embodiments, a network 104 may be a private network and a network 104′ a public network. In still another of these embodiments, networks 104 and 104′ may both be private networks.

The network 104 may be connected via wired or wireless links. Wired links may include Digital Subscriber Line (DSL), coaxial cable lines, or optical fiber lines. The wireless links may include BLUETOOTH, Wi-Fi, Worldwide Interoperability for Microwave Access (WiMAX), an infrared channel or satellite band. The wireless links may also include any cellular network standards used to communicate among mobile devices, including standards that qualify as 1G, 2G, 3G, or 4G. The network standards may qualify as one or more generations of mobile telecommunication standards by fulfilling a specification or standards such as the specifications maintained by the International Telecommunication Union. The 3G standards, for example, may correspond to the International Mobile Telecommunications-2000 (IMT-2000) specification, and the 4G standards may correspond to the International Mobile Telecommunications Advanced (IMT-Advanced) specification. Examples of cellular network standards include AMPS, GSM, GPRS, UMTS, LTE, LTE Advanced, Mobile WiMAX, and WiMAX-Advanced. Cellular network standards may use various channel access methods e.g. FDMA, TDMA, CDMA, or SDMA. In some embodiments, different types of data may be transmitted via different links and standards. In other embodiments, the same types of data may be transmitted via different links and standards.

The network 104 may be any type and/or form of network. The geographical scope of the network 104 may vary widely and the network 104 can be a body area network (BAN), a personal area network (PAN), a local-area network (LAN), e.g. Intranet, a metropolitan area network (MAN), a wide area network (WAN), or the Internet. The topology of the network 104 may be of any form and may include, e.g., any of the following: point-to-point, bus, star, ring, mesh, or tree. The network 104 may be an overlay network which is virtual and sits on top of one or more layers of other networks 104′. The network 104 may be of any such network topology as known to those ordinarily skilled in the art capable of supporting the operations described herein. The network 104 may utilize different techniques and layers or stacks of protocols, including, e.g., the Ethernet protocol, the internet protocol suite (TCP/IP), the ATM (Asynchronous Transfer Mode) technique, the SONET (Synchronous Optical Networking) protocol, or the SDH (Synchronous Digital Hierarchy) protocol. The TCP/IP internet protocol suite may include application layer, transport layer, internet layer (including, e.g., IPv6), or the link layer. The network 104 may be a type of a broadcast network, a telecommunications network, a data communication network, or a computer network.

In some embodiments, the system may include multiple, logically-grouped servers 106. In one of these embodiments, the logical group of servers may be referred to as a server farm 38 or a machine farm 38. In another of these embodiments, the servers 106 may be geographically dispersed. In other embodiments, a machine farm 38 may be administered as a single entity. In still other embodiments, the machine farm 38 includes a plurality of machine farms 38. The servers 106 within each machine farm 38 can be heterogeneous—one or more of the servers 106 or machines 106 can operate according to one type of operating system platform (e.g., WINDOWS NT, manufactured by Microsoft Corp. of Redmond, Wash.), while one or more of the other servers 106 can operate on according to another type of operating system platform (e.g., Unix, Linux, or Mac OS X).

In one embodiment, servers 106 in the machine farm 38 may be stored in high-density rack systems, along with associated storage systems, and located in an enterprise data center. In this embodiment, consolidating the servers 106 in this way may improve system manageability, data security, the physical security of the system, and system performance by locating servers 106 and high performance storage systems on localized high performance networks. Centralizing the servers 106 and storage systems and coupling them with advanced system management tools allows more efficient use of server resources.

The servers 106 of each machine farm 38 do not need to be physically proximate to another server 106 in the same machine farm 38. Thus, the group of servers 106 logically grouped as a machine farm 38 may be interconnected using a wide-area network (WAN) connection or a metropolitan-area network (MAN) connection. For example, a machine farm 38 may include servers 106 physically located in different continents or different regions of a continent, country, state, city, campus, or room. Data transmission speeds between servers 106 in the machine farm 38 can be increased if the servers 106 are connected using a local-area network (LAN) connection or some form of direct connection. Additionally, a heterogeneous machine farm 38 may include one or more servers 106 operating according to a type of operating system, while one or more other servers 106 execute one or more types of hypervisors rather than operating systems. In these embodiments, hypervisors may be used to emulate virtual hardware, partition physical hardware, virtualize physical hardware, and execute virtual machines that provide access to computing environments, allowing multiple operating systems to run concurrently on a host computer. Native hypervisors may run directly on the host computer. Hypervisors may include VMware ESX/ESXi, manufactured by VMWare, Inc., of Palo Alto, Calif.; the Xen hypervisor, an open source product whose development is overseen by Citrix Systems, Inc.; the HYPER-V hypervisors provided by Microsoft or others. Hosted hypervisors may run within an operating system on a second software level. Examples of hosted hypervisors may include VMware Workstation and VIRTUALBOX.

Management of the machine farm 38 may be de-centralized. For example, one or more servers 106 may comprise components, subsystems and modules to support one or more management services for the machine farm 38. In one of these embodiments, one or more servers 106 provide functionality for management of dynamic data, including techniques for handling failover, data replication, and increasing the robustness of the machine farm 38. Each server 106 may communicate with a persistent store and, in some embodiments, with a dynamic store.

Server 106 may be a file server, application server, web server, proxy server, appliance, network appliance, gateway, gateway server, virtualization server, deployment server, SSL VPN server, or firewall. In one embodiment, the server 106 may be referred to as a remote machine or a node. In another embodiment, a plurality of nodes 290 may be in the path between any two communicating servers.

Referring to FIG. 1B, a cloud computing environment is depicted. A cloud computing environment may provide client 102 with one or more resources provided by a network environment. The cloud computing environment may include one or more clients 102a-102n, in communication with the cloud 108 over one or more networks 104. Clients 102 may include, e.g., thick clients, thin clients, and zero clients. A thick client may provide at least some functionality even when disconnected from the cloud 108 or servers 106. A thin client or a zero client may depend on the connection to the cloud 108 or server 106 to provide functionality. A zero client may depend on the cloud 108 or other networks 104 or servers 106 to retrieve operating system data for the client device. The cloud 108 may include back end platforms, e.g., servers 106, storage, server farms or data centers.

The cloud 108 may be public, private, or hybrid. Public clouds may include public servers 106 that are maintained by third parties to the clients 102 or the owners of the clients. The servers 106 may be located off-site in remote geographical locations as disclosed above or otherwise. Public clouds may be connected to the servers 106 over a public network. Private clouds may include private servers 106 that are physically maintained by clients 102 or owners of clients. Private clouds may be connected to the servers 106 over a private network 104. Hybrid clouds 108 may include both the private and public networks 104 and servers 106.

The cloud 108 may also include a cloud based delivery, e.g. Software as a Service (SaaS) 110, Platform as a Service (PaaS) 112, and Infrastructure as a Service (IaaS) 114. IaaS may refer to a user renting the use of infrastructure resources that are needed during a specified time period. IaaS providers may offer storage, networking, servers or virtualization resources from large pools, allowing the users to quickly scale up by accessing more resources as needed. Examples of IaaS include AMAZON WEB SERVICES provided by Amazon.com, Inc., of Seattle, Wash., RACKSPACE CLOUD provided by Rackspace US, Inc., of San Antonio, Tex., Google Compute Engine provided by Google Inc. of Mountain View, Calif., or RIGHTSCALE provided by RightScale, Inc., of Santa Barbara, Calif. PaaS providers may offer functionality provided by IaaS, including, e.g., storage, networking, servers or virtualization, as well as additional resources such as, e.g., the operating system, middleware, or runtime resources. Examples of PaaS include WINDOWS AZURE provided by Microsoft Corporation of Redmond, Wash., Google App Engine provided by Google Inc., and HEROKU provided by Heroku, Inc. of San Francisco, Calif. SaaS providers may offer the resources that PaaS provides, including storage, networking, servers, virtualization, operating system, middleware, or runtime resources. In some embodiments, SaaS providers may offer additional resources including, e.g., data and application resources. Examples of SaaS include GOOGLE APPS provided by Google Inc., SALESFORCE provided by Salesforce.com Inc. of San Francisco, Calif., or OFFICE 365 provided by Microsoft Corporation. Examples of SaaS may also include data storage providers, e.g. DROPBOX provided by Dropbox, Inc. of San Francisco, Calif., Microsoft SKYDRIVE provided by Microsoft Corporation, Google Drive provided by Google Inc., or Apple ICLOUD provided by Apple Inc. of Cupertino, Calif.

Clients 102 may access IaaS resources with one or more IaaS standards, including, e.g., Amazon Elastic Compute Cloud (EC2), Open Cloud Computing Interface (OCCI), Cloud Infrastructure Management Interface (CIMI), or OpenStack standards. Some IaaS standards may allow clients access to resources over HTTP, and may use Representational State Transfer (REST) protocol or Simple Object Access Protocol (SOAP). Clients 102 may access PaaS resources with different PaaS interfaces. Some PaaS interfaces use HTTP packages, standard Java APIs, JavaMail API, Java Data Objects (JDO), Java Persistence API (JPA), Python APIs, web integration APIs for different programming languages including, e.g., Rack for Ruby, WSGI for Python, or PSGI for Perl, or other APIs that may be built on REST, HTTP, XML, or other protocols. Clients 102 may access SaaS resources through the use of web-based user interfaces, provided by a web browser (e.g. GOOGLE CHROME, Microsoft INTERNET EXPLORER, or Mozilla Firefox provided by Mozilla Foundation of Mountain View, Calif.). Clients 102 may also access SaaS resources through smartphone or tablet applications, including, e.g., Salesforce Sales Cloud, or Google Drive app. Clients 102 may also access SaaS resources through the client operating system, including, e.g., Windows file system for DROPBOX.

In some embodiments, access to IaaS, PaaS, or SaaS resources may be authenticated. For example, a server or authentication server may authenticate a user via security certificates, HTTPS, or API keys. API keys may include various encryption standards such as, e.g., Advanced Encryption Standard (AES). Data resources may be sent over Transport Layer Security (TLS) or Secure Sockets Layer (SSL).

The client 102 and server 106 may be deployed as and/or executed on any type and form of computing device, e.g. a computer, network device or appliance capable of communicating on any type and form of network and performing the operations described herein. FIGS. 1C and 1D depict block diagrams of a computing device 100 useful for practicing an embodiment of the client 102 or a server 106. As shown in FIGS. 1C and 1D, each computing device 100 includes a central processing unit 121, and a main memory unit 122. As shown in FIG. 1C, a computing device 100 may include a storage device 128, an installation device 116, a network interface 118, an I/O controller 123, display devices 124a-124n, a keyboard 126 and a pointing device 127, e.g. a mouse. The storage device 128 may include, without limitation, an operating system, software, and a software of a content distribution system (CDS) 120. As shown in FIG. 1D, each computing device 100 may also include additional optional elements, e.g. a memory port 103, a bridge 170, one or more input/output devices 130a-130n (generally referred to using reference numeral 130), and a cache memory 140 in communication with the central processing unit 121.

The central processing unit 121 is any logic circuitry that responds to and processes instructions fetched from the main memory unit 122. In many embodiments, the central processing unit 121 is provided by a microprocessor unit, e.g.: those manufactured by Intel Corporation of Mountain View, Calif.; those manufactured by Motorola Corporation of Schaumburg, Ill.; the ARM processor and TEGRA system on a chip (SoC) manufactured by Nvidia of Santa Clara, Calif.; the POWER7 processor, those manufactured by International Business Machines of White Plains, N.Y.; or those manufactured by Advanced Micro Devices of Sunnyvale, Calif. The computing device 100 may be based on any of these processors, or any other processor capable of operating as described herein. The central processing unit 121 may utilize instruction level parallelism, thread level parallelism, different levels of cache, and multi-core processors. A multi-core processor may include two or more processing units on a single computing component. Examples of a multi-core processors include the AMD PHENOM IIX2, INTEL CORE i5 and INTEL CORE i7.

Main memory unit 122 may include one or more memory chips capable of storing data and allowing any storage location to be directly accessed by the microprocessor 121. Main memory unit 122 may be volatile and faster than storage 128 memory. Main memory units 122 may be Dynamic random access memory (DRAM) or any variants, including static random access memory (SRAM), Burst SRAM or SynchBurst SRAM (BSRAM), Fast Page Mode DRAM (FPM DRAM), Enhanced DRAM (EDRAM), Extended Data Output RAM (EDO RAM), Extended Data Output DRAM (EDO DRAM), Burst Extended Data Output DRAM (BEDO DRAM), Single Data Rate Synchronous DRAM (SDR SDRAM), Double Data Rate SDRAM (DDR SDRAM), Direct Rambus DRAM (DRDRAM), or Extreme Data Rate DRAM (XDR DRAM). In some embodiments, the main memory 122 or the storage 128 may be non-volatile; e.g., non-volatile read access memory (NVRAM), flash memory non-volatile static RAM (nvSRAM), Ferroelectric RAM (FeRAM), Magnetoresistive RAM (MRAM), Phase-change memory (PRAM), conductive-bridging RAM (CBRAM), Silicon-Oxide-Nitride-Oxide-Silicon (SONOS), Resistive RAM (RRAM), Racetrack, Nano-RAM (NRAM), or Millipede memory. The main memory 122 may be based on any of the above described memory chips, or any other available memory chips capable of operating as described herein. In the embodiment shown in FIG. 1C, the processor 121 communicates with main memory 122 via a system bus 150 (described in more detail below). FIG. 1D depicts an embodiment of a computing device 100 in which the processor communicates directly with main memory 122 via a memory port 103. For example, in FIG. 1D the main memory 122 may be DRDRAM.

FIG. 1D depicts an embodiment in which the main processor 121 communicates directly with cache memory 140 via a secondary bus, sometimes referred to as a backside bus. In other embodiments, the main processor 121 communicates with cache memory 140 using the system bus 150. Cache memory 140 typically has a faster response time than main memory 122 and is typically provided by SRAM, BSRAM, or EDRAM. In the embodiment shown in FIG. 1D, the processor 121 communicates with various I/O devices 130 via a local system bus 150. Various buses may be used to connect the central processing unit 121 to any of the I/O devices 130, including a PCI bus, a PCI-X bus, or a PCI-Express bus, or a NuBus. For embodiments in which the I/O device is a video display 124, the processor 121 may use an Advanced Graphics Port (AGP) to communicate with the display 124 or the I/O controller 123 for the display 124. FIG. 1D depicts an embodiment of a computer 100 in which the main processor 121 communicates directly with I/O device 130b or other processors 121′ via HYPERTRANSPORT, RAPIDIO, or INFINIBAND communications technology. FIG. 1D also depicts an embodiment in which local busses and direct communication are mixed: the processor 121 communicates with I/O device 130a using a local interconnect bus while communicating with I/O device 130b directly.

A wide variety of I/O devices 130a-130n may be present in the computing device 100. Input devices may include keyboards, mice, trackpads, trackballs, touchpads, touch mice, multi-touch touchpads and touch mice, microphones, multi-array microphones, drawing tablets, cameras, single-lens reflex camera (SLR), digital SLR (DSLR), CMOS sensors, accelerometers, infrared optical sensors, pressure sensors, magnetometer sensors, angular rate sensors, depth sensors, proximity sensors, ambient light sensors, gyroscopic sensors, or other sensors. Output devices may include video displays, graphical displays, speakers, headphones, inkjet printers, laser printers, and 3D printers.

Devices 130a-130n may include a combination of multiple input or output devices, including, e.g., Microsoft KINECT, Nintendo Wiimote for the WII, Nintendo WII U GAMEPAD, or Apple IPHONE. Some devices 130a-130n allow gesture recognition inputs through combining some of the inputs and outputs. Some devices 130a-130n provides for facial recognition which may be utilized as an input for different purposes including authentication and other commands. Some devices 130a-130n provides for voice recognition and inputs, including, e.g., Microsoft KINECT, SIRI for IPHONE by Apple, Google Now or Google Voice Search.

Additional devices 130a-130n have both input and output capabilities, including, e.g., haptic feedback devices, touchscreen displays, or multi-touch displays. Touchscreen, multi-touch displays, touchpads, touch mice, or other touch sensing devices may use different technologies to sense touch, including, e.g., capacitive, surface capacitive, projected capacitive touch (PCT), in-cell capacitive, resistive, infrared, waveguide, dispersive signal touch (DST), in-cell optical, surface acoustic wave (SAW), bending wave touch (BWT), or force-based sensing technologies. Some multi-touch devices may allow two or more contact points with the surface, allowing advanced functionality including, e.g., pinch, spread, rotate, scroll, or other gestures. Some touchscreen devices, including, e.g., Microsoft PIXELSENSE or Multi-Touch Collaboration Wall, may have larger surfaces, such as on a table-top or on a wall, and may also interact with other electronic devices. Some I/O devices 130a-130n, display devices 124a-124n or group of devices may be augment reality devices. The I/O devices may be controlled by an I/O controller 123 as shown in FIG. 1C. The I/O controller may control one or more I/O devices, such as, e.g., a keyboard 126 and a pointing device 127, e.g., a mouse or optical pen. Furthermore, an I/O device may also provide storage and/or an installation medium 116 for the computing device 100. In still other embodiments, the computing device 100 may provide USB connections (not shown) to receive handheld USB storage devices. In further embodiments, an I/O device 130 may be a bridge between the system bus 150 and an external communication bus, e.g. a USB bus, a SCSI bus, a FireWire bus, an Ethernet bus, a Gigabit Ethernet bus, a Fibre Channel bus, or a Thunderbolt bus.

In some embodiments, display devices 124a-124n may be connected to I/O controller 123. Display devices may include, e.g., liquid crystal displays (LCD), thin film transistor LCD (TFT-LCD), blue phase LCD, electronic papers (e-ink) displays, flexile displays, light emitting diode displays (LED), digital light processing (DLP) displays, liquid crystal on silicon (LCOS) displays, organic light-emitting diode (OLED) displays, active-matrix organic light-emitting diode (AMOLED) displays, liquid crystal laser displays, time-multiplexed optical shutter (TMOS) displays, or 3D displays. Examples of 3D displays may use, e.g. stereoscopy, polarization filters, active shutters, or autostereoscopy. Display devices 124a-124n may also be a head-mounted display (HMD). In some embodiments, display devices 124a-124n or the corresponding I/O controllers 123 may be controlled through or have hardware support for OPENGL or DIRECTX API or other graphics libraries.

In some embodiments, the computing device 100 may include or connect to multiple display devices 124a-124n, which each may be of the same or different type and/or form. As such, any of the I/O devices 130a-130n and/or the I/O controller 123 may include any type and/or form of suitable hardware, software, or combination of hardware and software to support, enable or provide for the connection and use of multiple display devices 124a-124n by the computing device 100. For example, the computing device 100 may include any type and/or form of video adapter, video card, driver, and/or library to interface, communicate, connect or otherwise use the display devices 124a-124n. In one embodiment, a video adapter may include multiple connectors to interface to multiple display devices 124a-124n. In other embodiments, the computing device 100 may include multiple video adapters, with each video adapter connected to one or more of the display devices 124a-124n. In some embodiments, any portion of the operating system of the computing device 100 may be configured for using multiple displays 124a-124n. In other embodiments, one or more of the display devices 124a-124n may be provided by one or more other computing devices 100a or 100b connected to the computing device 100, via the network 104. In some embodiments software may be designed and constructed to use another computer's display device as a second display device 124a for the computing device 100. For example, in one embodiment, an Apple iPad may connect to a computing device 100 and use the display of the device 100 as an additional display screen that may be used as an extended desktop. One ordinarily skilled in the art will recognize and appreciate the various ways and embodiments that a computing device 100 may be configured to have multiple display devices 124a-124n.

Referring again to FIG. 1C, the computing device 100 may comprise a storage device 128 (e.g. one or more hard disk drives or redundant arrays of independent disks) for storing an operating system or other related software, and for storing application software programs such as any program related to the software 120 for the content distribution system. Examples of storage device 128 include, e.g., hard disk drive (HDD); optical drive including CD drive, DVD drive, or BLU-RAY drive; solid-state drive (SSD); USB flash drive; or any other device suitable for storing data. Some storage devices may include multiple volatile and non-volatile memories, including, e.g., solid state hybrid drives that combine hard disks with solid state cache. Some storage device 128 may be non-volatile, mutable, or read-only. Some storage device 128 may be internal and connect to the computing device 100 via a bus 150. Some storage device 128 may be external and connect to the computing device 100 via a I/O device 130 that provides an external bus. Some storage device 128 may connect to the computing device 100 via the network interface 118 over a network 104, including, e.g., the Remote Disk for MACBOOK AIR by Apple. Some client devices 100 may not require a non-volatile storage device 128 and may be thin clients or zero clients 102. Some storage device 128 may also be used as a installation device 116, and may be suitable for installing software and programs. Additionally, the operating system and the software can be run from a bootable medium, for example, a bootable CD, e.g. KNOPPIX, a bootable CD for GNU/Linux that is available as a GNU/Linux distribution from knoppix.net.

Client device 100 may also install software or application from an application distribution platform. Examples of application distribution platforms include the App Store for iOS provided by Apple, Inc., the Mac App Store provided by Apple, Inc., GOOGLE PLAY for Android OS provided by Google Inc., Chrome Webstore for CHROME OS provided by Google Inc., and Amazon Appstore for Android OS and KINDLE FIRE provided by Amazon.com, Inc. An application distribution platform may facilitate installation of software on a client device 102. An application distribution platform may include a repository of applications on a server 106 or a cloud 108, which the clients 102a-102n may access over a network 104. An application distribution platform may include application developed and provided by various developers. A user of a client device 102 may select, purchase and/or download an application via the application distribution platform.

Furthermore, the computing device 100 may include a network interface 118 to interface to the network 104 through a variety of connections including, but not limited to, standard telephone lines LAN or WAN links (e.g., 802.11, T1, T3, Gigabit Ethernet, Infiniband), broadband connections (e.g., ISDN, Frame Relay, ATM, Gigabit Ethernet, Ethernet-over-SONET, ADSL, VDSL, BPON, GPON, fiber optical including FiOS), wireless connections, or some combination of any or all of the above. Connections can be established using a variety of communication protocols (e.g., TCP/IP, Ethernet, ARCNET, SONET, SDH, Fiber Distributed Data Interface (FDDI), IEEE 802.11a/b/g/n/ac CDMA, GSM, WiMax and direct asynchronous connections). In one embodiment, the computing device 100 communicates with other computing devices 100′ via any type and/or form of gateway or tunneling protocol e.g. Secure Socket Layer (SSL) or Transport Layer Security (TLS), or the Citrix Gateway Protocol manufactured by Citrix Systems, Inc. of Ft. Lauderdale, Fla. The network interface 118 may comprise a built-in network adapter, network interface card, PCMCIA network card, EXPRESSCARD network card, card bus network adapter, wireless network adapter, USB network adapter, modem or any other device suitable for interfacing the computing device 100 to any type of network capable of communication and performing the operations described herein.

A computing device 100 of the sort depicted in FIGS. 1B and 1C may operate under the control of an operating system, which controls scheduling of tasks and access to system resources. The computing device 100 can be running any operating system such as any of the versions of the MICROSOFT WINDOWS operating systems, the different releases of the Unix and Linux operating systems, any version of the MAC OS for Macintosh computers, any embedded operating system, any real-time operating system, any open source operating system, any proprietary operating system, any operating systems for mobile computing devices, or any other operating system capable of running on the computing device and performing the operations described herein. Typical operating systems include, but are not limited to: WINDOWS 2000, WINDOWS Server 2012, WINDOWS CE, WINDOWS Phone, WINDOWS XP, WINDOWS VISTA, and WINDOWS 7, WINDOWS RT, and WINDOWS 8 all of which are manufactured by Microsoft Corporation of Redmond, Wash.; MAC OS and iOS, manufactured by Apple, Inc. of Cupertino, Calif.; and Linux, a freely-available operating system, e.g. Linux Mint distribution (“distro”) or Ubuntu, distributed by Canonical Ltd. of London, United Kingom; or Unix or other Unix-like derivative operating systems; and Android, designed by Google, of Mountain View, Calif., among others. Some operating systems, including, e.g., the CHROME OS by Google, may be used on zero clients or thin clients, including, e.g., CHROMEBOOKS.

The computer system 100 can be any workstation, telephone, desktop computer, laptop or notebook computer, netbook, ULTRABOOK, tablet, server, handheld computer, mobile telephone, smartphone or other portable telecommunications device, media playing device, a gaming system, mobile computing device, or any other type and/or form of computing, telecommunications or media device that is capable of communication. The computer system 100 has sufficient processor power and memory capacity to perform the operations described herein. In some embodiments, the computing device 100 may have different processors, operating systems, and input devices consistent with the device. The Samsung GALAXY smartphones, e.g., operate under the control of Android operating system developed by Google, Inc. GALAXY smartphones receive input via a touch interface.

In some embodiments, the computing device 100 is a gaming system. For example, the computer system 100 may comprise a PLAYSTATION 3, or PERSONAL PLAYSTATION PORTABLE (PSP), or a PLAYSTATION VITA device manufactured by the Sony Corporation of Tokyo, Japan, a NINTENDO DS, NINTENDO 3DS, NINTENDO WII, or a NINTENDO WII U device manufactured by Nintendo Co., Ltd., of Kyoto, Japan, an XBOX 360 device manufactured by the Microsoft Corporation of Redmond, Wash.

In some embodiments, the computing device 100 is a digital audio player such as the Apple IPOD, IPOD Touch, and IPOD NANO lines of devices, manufactured by Apple Computer of Cupertino, Calif. Some digital audio players may have other functionality, including, e.g., a gaming system or any functionality made available by an application from a digital application distribution platform. For example, the IPOD Touch may access the Apple App Store. In some embodiments, the computing device 100 is a portable media player or digital audio player supporting file formats including, but not limited to, MP3, WAV, M4A/AAC, WMA Protected AAC, RIFF, Audible audiobook, Apple Lossless audio file formats and .mov, .m4v, and .mp4 MPEG-4 (H.264/MPEG-4 AVC) video file formats.

In some embodiments, the computing device 100 is a tablet e.g. the IPAD line of devices by Apple; GALAXY TAB family of devices by Samsung; or KINDLE FIRE, by Amazon.com, Inc. of Seattle, Wash. In other embodiments, the computing device 100 is a eBook reader, e.g. the KINDLE family of devices by Amazon.com, or NOOK family of devices by Barnes & Noble, Inc. of New York City, N.Y.

In some embodiments, the communications device 102 includes a combination of devices, e.g. a smartphone combined with a digital audio player or portable media player. For example, one of these embodiments is a smartphone, e.g. the IPHONE family of smartphones manufactured by Apple, Inc.; a Samsung GALAXY family of smartphones manufactured by Samsung, Inc; or a Motorola DROID family of smartphones. In yet another embodiment, the communications device 102 is a laptop or desktop computer equipped with a web browser and a microphone and speaker system, e.g. a telephony headset. In these embodiments, the communications devices 102 are web-enabled and can receive and initiate phone calls. In some embodiments, a laptop or desktop computer is also equipped with a webcam or other video capture device that enables video chat and video call.

In some embodiments, the status of one or more machines 102, 106 in the network 104 is monitored, generally as part of network management. In one of these embodiments, the status of a machine may include an identification of load information (e.g., the number of processes on the machine, CPU and memory utilization), of port information (e.g., the number of available communication ports and the port addresses), or of session status (e.g., the duration and type of processes, and whether a process is active or idle). In another of these embodiments, this information may be identified by a plurality of metrics, and the plurality of metrics can be applied at least in part towards decisions in load distribution, network traffic management, and network failure recovery as well as any aspects of operations of the present solution described herein. Aspects of the operating environments and components described above will become apparent in the context of the systems and methods disclosed herein.

### B. Systems and Methods of Improving the Probability of Grammatical Error Detection

Various embodiments disclosed herein are directed to a grammar correction system for improving the probability of grammatical error detection and correction. In some implementations, a grammar correction system can be configured to provide a tool through which writers or other users can identify and correct grammatical errors in a piece of writing. The piece of writing can be any collection of words capable of being analyzed for grammatical errors. In some implementations, the piece of writing can be any document or resource that includes any collection of words capable of being analyzed for grammatical errors.

In some implementations, the grammar correction system can identify grammatical errors using an algorithm that implements error-based rules. Stated in another way, the rules identify errors and as such, if the writing being analyzed has characteristics that match the error-based rules, the grammar correction system detects an error. In contrast, existing grammar correction systems rely on grammar-based rules to identify grammatical errors. Grammar-based rules can identify errors when a sequence of words of a writing does not conform to any of the grammar-based rules that make up the algorithms. This can require the algorithm to make sure every applicable grammar-based rule is satisfied to determine that there are no errors in the sequence of words. As such, algorithms that rely on grammar-based rules require checking to see that the sequence of words satisfies a plurality of rules in order to determine that there are no errors in the sequence of words. This can result in a more tedious process which consequently can slow the speed at which a piece of writing can be reviewed for grammatical errors.

According to yet another aspect, a system for detecting grammatical errors in a sequence of words using a set of error detection rules is described. The system includes a grammar corrector having a memory and one or more processors. The grammar corrector is configured to identify, by a grammatical checker configured on grammar corrector, word data representing a sequence of words to be analyzed for grammatical errors. The grammar corrector is configured to determine, by the grammatical checker, that each of the sequence of words matches a word in a corpus represented by corpus data stored on the memory. The grammar corrector is configured to assign, by a third-party tagging system configured on the grammar corrector, each of the words of the sequence of words with one or more third-party tags. The grammar corrector stores, for each of the words, the one or more third-party tags assigned to the word with the word. The grammar corrector is configured to compare, by the grammatical checker, each of the words of the sequence of words to a predetermined list of words to be tagged using custom tags instead of third-party tags. The grammar corrector is configured to identify, by the grammatical checker, based on the comparison, a word of the sequence of words that is included in the predetermined list of words. The grammar corrector is configured to assign, by a first tagging system configured on the grammar corrector, the identified word with a custom tag. The grammar corrector stores the custom tag with the identified word. The grammar corrector is configured to generate, by the grammatical checker, a first sequence of tags including the custom tag and the one or more third-party tags, the sequence of tags arranged in the order of the words in the sequence of words. The grammar corrector is configured to identify, by the grammatical checker, an error-based rule that specifies a second sequence of tags representative of a grammatical error and corresponding third sequence of tags representative of a correction of the grammatical error of the second sequence of tags. The grammar corrector stores the second sequence of tags and the third sequence of tags. The grammar corrector is configured to determine, by the grammatical checker, that the first sequence of tags matches the second sequence of tags of the error-based rule. The grammar corrector is configured to responsive to determining that the first sequence of tags matches the second sequence of tags of the error-based rule, adjust the sequence of words to a revised sequence of words such that a revised sequence of tags based on the revised sequence of words matches the third sequence of tags. The grammar corrector is configured to provide, for display, the revised sequence of words.

In some implementations, the grammar corrector receives a document including the sequence of words to be analyzed for grammatical errors. In some implementations, the grammar corrector is further configured to determine, by the grammatical checker, that a misspelt word of the sequence of words does not match any word in the corpus. The grammar corrector is configured to determine, based on comparing characters of the misspelt word, that the misspelt word is similar to one or more words of the corpus. The grammar corrector is configured to identify tags associated with each of the one or more words of the corpus to which the misspelt word is similar. The grammar corrector is configured to assign the misspelt word a custom tag indicating that the word is misspelt and assign the misspelt word one or more tags based on the words of the corpus to which the misspelt word is similar.

In some implementations, the custom tags assigned to the word that is included in the predetermined list of words are based on a combination of a part-of-speech tag, a singular or plural tag and a tense tag.

In some implementations, the grammar corrector is further configured to identify, based on a comparison of the first sequence of tags and the third sequence of tags, a subset of tags of the first sequence of tags that are different from a corresponding subset of the third sequence of tags. The grammar corrector is configured to identify a subset of words of the sequence of words corresponding to the subset of tags. The grammar corrector is configured to replace the subset of words with a revised subset of words from the corpus that when assigned tags, match the subset of the third sequence of tags.

In some implementations, replacing the subset of words with a revised subset of words includes identifying the tags of the subset of the third sequence of tags and identifying, from the corpus, words corresponding to the tags of the subset of the third sequence of tags as the revised subset of words.

In some implementations, the grammar corrector is further configured to identify one or more characteristics of a writer of the sequence of words. The grammar corrector is configured to determine, based on the characteristics of the writer, an order in which the grammar corrector applies one or more of a plurality of error-based rules to determine if the sequence of words includes a grammatical error and apply the plurality of error-based rules based on the determined order. In some implementations, the characteristics of the writer of the sequence of words include a geographic region to which the writer belongs. In some implementations, the grammar corrector determines the characteristics of the writer by analyzing the sequence of words.

In some implementations, the grammar corrector is further configured to compute a score indicating a level of proficiency of a document in which the sequence of words are included based on a quantity of different error-based rules that matched the sequence of words and provide the computed score for display.

In some implementations, the grammar correction system can be configured to receive information associated with a writer of the piece of writing. In some implementations, the information received can include demographic information of a writer, including but not limited to, a country of origin, a native language of the writer, the writer's age and gender, amongst others. The grammar correction system can then select one of a plurality of grammar correction protocols to implement when reviewing the piece of writing written by the writer based on the writer's demographic information. The grammar correction system can select a grammar correction protocol from a plurality of grammar correction protocols that is best suited to detect grammatical errors based in part on the writer's demographic information. This is because the writer's demographic information can influence or be attributed to certain types of grammatical errors. As such, the grammar correction system can select a grammar correction protocol geared towards specific demographics to improve the speed and accuracy of grammatical error detection in a piece of writing.

In some implementations, a grammar correction protocol is a collection of grammar correction rules arranged in a particular order. The order or hierarchy in which the grammar correction rules are arranged can affect the speed and accuracy in which errors are detected and corrected. In some implementations, the order in which the grammar correction rules are arranged can be influenced by the demographic information of the writer. In some implementations, writers having similar demographic profiles are more likely to make the same types of errors when compared to writers having different demographic profiles. Further, in some implementations, a grammar correction protocol may not include each and every grammar correction rule. As such, a first grammar correction protocol can include a first plurality of grammar correction rules, while a second grammar correction protocol can include a second plurality of grammar correction rules having at least one grammar correction rule that is different from the grammar correction rules included in the first plurality of grammar correction rules.

In some implementations, the grammar correction system can also score a writer's piece of writing to provide the writer an indication of the writer's proficiency in the language. The grammar correction system can also store previously submitted pieces of writings and identify trends in the writer's proficiency of the language. A score-based feedback system can help a writer gauge his or her performance and proficiency over a period of time.

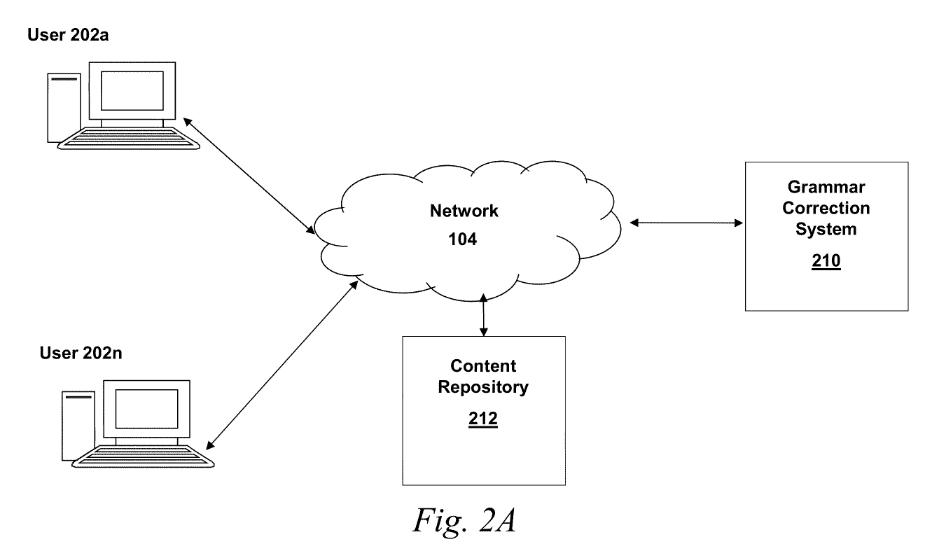

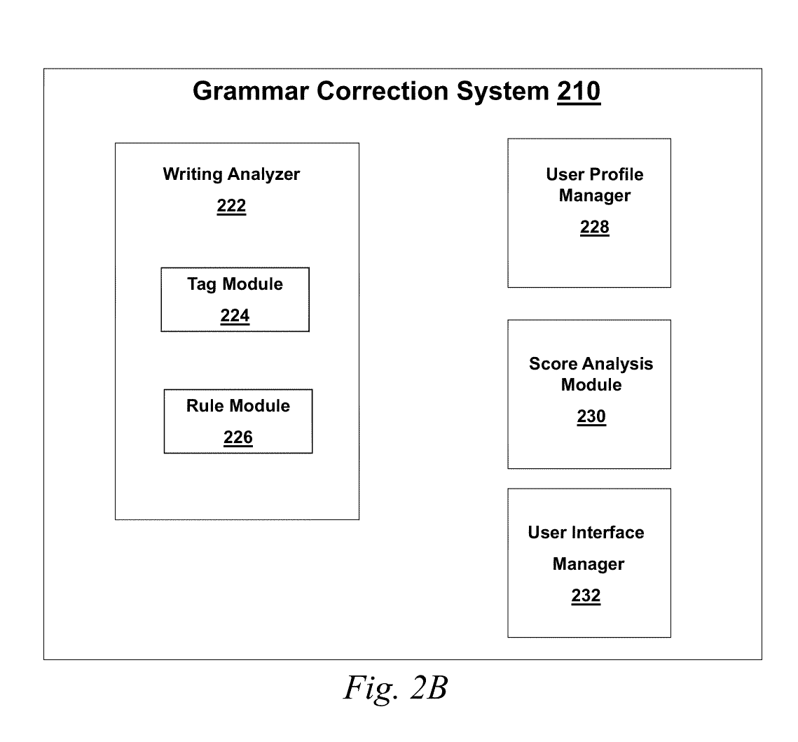

FIG. 2A is a block diagram illustrating a computer networked environment for providing improved grammatical error detection in accordance with various embodiments. A grammar correction system 210 can be configured to communicate with one or more users 202a-202n over a network, such as the network 104. The users 202 can be individuals or entities that desire to provide writings to the grammar correction system and have the grammar correction system identify grammatical errors in the writings. In some implementations, the users 202 are writers of the writings. In some implementations, the users 202 are not the writers of the writings but desire to have the grammar correction system identify grammatical errors in the writings.

The grammar correction system 210 may execute on one or more servers, such as the server 106 shown in FIG. 1A. The grammar correction system 210, and any modules or components thereof, may comprise one or more applications, programs, libraries, services, processes, scripts, tasks or any type and form of executable instructions executing on one or more devices, such as servers. The grammar correction system 210, and any modules or components thereof, may use any type and form of database for storage and retrieval of data. The grammar correction system 210 may comprise function, logic and operations to perform any of the methods described herein.

In some implementations, users can communicate with the grammar correction system 210 via computing devices of the users. In some implementations, a user, via a user computing device, can communicate with the grammar correction system 210 via a web-based browser or through a native application installed on the computing device. In some implementations, the native application can be running in the background of the computing device and can be configured to allow the user to communicate with the grammar correction system 210.

In some implementations, users 202 can communicate with the grammar correction system 210 via computing devices of the users. A user 202 can communicate with the grammar correction system 210 via a web browser or a native application installed on a computing device of the user. The grammar correction system 210 can present a user interface to the user 202 through which the user can provide writings for correction. In some implementations, the user interface can be configured to allow the user to share writings with other users via the grammar correction system. In some implementations, the user interface can be configured to allow a user to send a document to another user via the grammar correction system 210 such that the grammar correction system 210 analyzes the document for grammatical errors and forwards a document free of grammatical errors to the other user. In some implementations, the grammar correction system 210 can send the document to the other user via a native application installed on a user computing device of the other user or via email or some other messaging delivery system.

The grammar correction system 210 may be designed, constructed and/or configured to communicate with and/or interface to a plurality of different content repositories 212. In some embodiments, the grammar correction system 210 can communicate with the content repositories 212 over one or more networks 104, such as to a remote server or cloud storage service. In some embodiments, the content repositories may be located in a network separate from the network of the content distribution system, such as in the cloud. Content repositories 212 may include any type and form of storage or storage service for storing data such as digital content. Examples of such content repositories 212 include servers or services provided by Dropbox, Box.com, Google, amongst others. In some embodiments, the content repositories 212 are maintained by the grammar correction system 210. In some embodiments, the content repositories are located local to the grammar correction system 210. In some implementations, the content repositories 212 can store content, including writings provided by one or more users, rules used to identify grammatical errors, user profile information associated with one or more users, statistical data associated with the users, amongst others.

FIG. 2B is a block diagram of an embodiment of a grammar correction system for providing improved grammatical error detection. The grammar correction system 210 can be configured to receive a writing or document including a sequence of words to be analyzed. The grammar correction system 210 can analyze the writing to determine if the writing includes any grammatical errors by applying one or more error-based rules. In some implementations, the grammar correction system 210 can execute an algorithm that determines an order in which the error-based rules or the type of error-based rules are applied to the sequence of words. In some implementations, the order in which the error-based rules are applied to the sequence of words is based in part on information associated with the user, including but not limited to demographic information. Examples of various types of demographic information that may be used to influence the order in which the error-based rules or the type of error-based rules are applied includes a native language of the speaker, a country of origin of the writer, the writer's age, gender, amongst others. The grammar correction system 210 can include a writing analyzer 222, which can include a tag module 224 and a rule module 226. In some implementations, the writing analyzer 222 can include a grammatical checker and a grammar corrector. The grammar correction system 210 can further include a user profile manager 228, a score analysis module 230 and a user interface manager 232, details of which are provided below.

The writing analyzer 222 may comprise one or more applications, programs, libraries, services, processes, scripts, tasks or any type and form of executable instructions executing on one or more devices, and can be designed, constructed or configured to analyze a writing for grammatical errors. The writing analyzer 222 can be configured to identify a writing to be analyzed. The writing can be a document or resource that includes a sequence of words. In some implementations, the writing analyzer can be configured to identify, from a document, resource or any collection of words, one or more sequence of words that can be analyzed. The sequence of words can be any text string including one or more words. In some implementations, the writing analyzer can identify a sentence or phrase as a sequence of words.

In some implementations, the writing analyzer 222 can include a grammatical checker that is configured on the grammar correction system. The grammatical checker can receive or identify word data representing a sequence of words to be analyzed for grammatical errors. The grammatical checker can be configured to determine that each of the sequence of words matches a word in a corpus represented by corpus data stored on the device. In some implementations, the corpus can be one or more dictionaries. In some implementations, the corpus can be any list of words. In some implementations, the corpus data can be stored on the grammar correction system. In some implementations, the corpus data can be stored remote the grammar correction system but may be accessible by the grammar correction system. In some implementations, the corpus data may be stored on the grammar correction system when being accessed by the grammar correction system.

The grammatical checker can be configured to determine that each word of the sequence of words matches a word in the corpus. If a word of the sequence of words does not match any of the words included in the corpus, the grammatical checker may determine that the word is misspelt. In some implementations, the grammatical checker may determine that a word matches a word in the corpus by identifying each character or letter of the word and determining a position of the character of the word relative to the other characters of the word. The grammatical checker can then compare the word with each of the words in the corpus. To compare the word with words in the corpus, the grammatical checker can identify a first character of the word, identify words in the corpus that begin with the same character. The grammatical checker can then recursively check for the next character of the word, from the identified words in the corpus, a subset of the words that have a next character that matches the next character of the word. The grammatical checker can determine that the word does not match a word in the corpus if the sequence of characters of the word do not match a complete sequence of characters of any word in the corpus.

The grammatical checker can be configured to assign, to the word, a tag specifying that the word is misspelt responsive to determining that the word does not match any word in the corpus. The grammatical checker can be configured to identify words similar to the misspelt word based on a comparison of the characters of the misspelt word and words in the corpus. In some implementations, the grammatical checker can be configured to identify the sequence of words to understand the grammatical context of the misspelt word to identify a word that can replace the misspelt word. In some implementations, to determine the word that can replace the misspelt word, the grammatical checker may be configured to apply one or more tags to each of the words in the sequence and determine, based on one or more rules for detecting errors, an appropriate tag to be associated with the misspelt word. Based on the tag of the misspelt word as well as the characters of the misspelt word, the grammatical checker can be configured to identify the word in the corpus that would be a suitable replacement for the misspelt word.

A third-party tagging system can be configured on the grammar correction system and that may be implemented by the grammatical checker of the writing analyzer 222. The third-party tagging system may assign one or more third-party tags to each of the words of the sequence of words. The writing analyzer may store, for each word of the sequence of words, the one or more third-party tags with the corresponding word in memory. In some implementations, the third-party tagging system may utilize one or more third-party tagging tools for tagging the words. The third-party tagging tools may be available online. In some implementations, a database including a plurality of words and corresponding third-party tags may be stored on the grammar correction system. In some implementations, the grammar correction system can employ more than one third-party tagging system. In some such implementations, the grammar correction system can select tags of a particular third-party tagging system for certain words and select tags of another third-party tagging system for other words.

The grammatical checker can be configured to compare one or more of the words of the sequence of words to a predetermined list of words to be tagged using custom tags instead of third-party tags. In some implementations, the grammatical checker can be configured to compare each of the words of the sequence of words to a predetermined list of words to be tagged using custom tags instead of third-party tags. In some implementations, the grammatical checker can maintain a predetermined list of words that third-party tagging systems tag incorrectly or improperly such that third-party systems that detect errors are unable to detect errors caused in part by the use of the word in the sequence of words. Each word in the predetermined list of words can have one or more custom tags specific to the word that may be assigned by a first tagging system instead of a third-party system. In some implementations, the grammatical checker can identify, based on the comparison of each word of the sequence of words with the predetermined list of words, a word of the sequence of words that is included in the predetermined list of words. An example of such a word is the word “is.”

A first tagging system can be configured on the grammar correction system and that may be implemented by the grammatical checker of the writing analyzer 222. The first tagging system may assign a custom tag to the word of the sequence of words that is identified to match a word in the predetermined list of words. The writing analyzer may store the custom tag with the identified word in memory. In some implementations, the first tagging system may identify a custom tag to assign to the word based on a lookup of the word in a database that includes a plurality of words and custom tags associated with the plurality of tags. In some implementations, the database may be stored on the grammar correction system. In some implementations, the custom tags assigned to the word that is included in the predetermined list of words may be based on a combination of a part-of-speech tag, a singular or plural tag and a tense tag. An example of a custom tag can be “Bee3srx”, which can be associated with the word “is” and can indicate that the word “is” is related to the verb “to be” (Bee), is third-person (3) singular (s), present (r), and is not negative (x).

In some implementations, the grammar correction system can be configured to identify a function of the word included in the predetermined list of words based on the context of the sequence of words. In some implementations, the word may be ambiguous in that the word may be used as different parts of speech based on the context in which the word is used. In some implementations, the grammar correction system can apply one or more rules to determine the function of the word and assign a tag based on the function of the word. For instance, in the phrase “I see her,” the word ‘her’ is a direct object. However, in the phrase “I see her book,” the word ‘her’ is a possessive adjective. The grammar correction system can be able to determine the function of the word ‘her’ and assign a custom tag based on the function of the word ‘her’ in the sequence of words.

In some implementations in which the grammatical checker determines that the sequence of words includes a misspelt word, the grammatical checker can determine, based on comparing characters of the misspelt word, that the misspelt word is similar to one or more words of the corpus, identify tags associated with each of the one or more words of the corpus to which the misspelt word is similar, assign the misspelt word a custom tag indicating that the word is misspelt and assign the misspelt word one or more tags based on the words of the corpus to which the misspelt word is similar.

The grammatical checker may be configured to generate a first sequence of tags including the custom tag and the one or more third-party tags. The grammatical checker may arrange the tags in the sequence of tags in the order of the words in the sequence of words such that all tags associated with a first word in the sequence of words may correspond to a first position in the sequence of tags and all tags associated with a second word in the sequence of words may correspond to a second position in the sequence of tags and so on. In some implementations, the grammatical checker may generate tag data representing the first sequence of tags.

The grammatical checker may be configured to identify one or more error-based rules. Each of the error-based rules can be used to identify one or more grammatical errors in a sequence of words by comparing the sequence of tags generated from the sequence of words with a predetermined sequence of tags identified to be associated with a grammatical error. In some implementations, an error-based rule can specify a second sequence of tags representative of a grammatical error. That is, if words corresponding to the second sequence of tags were arranged in a sequence based on the second sequence of tags, the sequence of words would include a grammatical error. The error-based rule can also specify a corresponding third sequence of tags that is representative of a correction of the grammatical error of the second sequence of tags. That is, if words corresponding to the third sequence of tags were arranged in a sequence based on the third sequence of tags, the sequence of words would be grammatically correct. In some implementations, the grammar correction system can store the second sequence of tags and the third sequence of tags for each of the error-based rules.

The grammatical checker can be configured to determine that the first sequence of tags matches the second sequence of tags of the error-based rule. To do so, the grammatical checker can identify the tags of the first sequence of tags corresponding to the first word of the sequence of words and check if these tags match the first set of tags of the second sequence of tags. In some implementations, a plurality of tags can be combined to form a combination tag and as such, each word may be represented by a single tag that is a combination of multiple tags. If all of the tags of the first sequence of tags matches all of the tags of the second sequence of tags, the grammatical checker can be configured to determine that the first sequence of words includes a grammatical error.

A grammar corrector can be configured on the grammar correction system and may be implemented by the grammatical checker of the writing analyzer 222. The grammar corrector can, responsive to determining that the first sequence of tags matches the second sequence of tags of the error-based rule, adjust the sequence of words to a revised sequence of words. In some implementations, adjusting the sequence of words to a revised sequence of words can include rearranging the words in the sequence of words or replacing words in the sequence of words with other words.

In some implementations, to adjust the sequence of words to a revised sequence of words, the grammar corrector can identify, based on a comparison of the first sequence of tags and the third sequence of tags, a subset of tags of the first sequence of tags that are different from a corresponding subset of the third sequence of tags. The grammar corrector can then identify a subset of words of the sequence of words corresponding to the subset of tags. The grammar corrector can then replace the subset of words with a revised subset of words from the corpus that when assigned tags, match the subset of the third sequence of tags. In some implementations, replacing the subset of words with a revised subset of words include identifying the tags of the subset of the third sequence of tags and identifying, from the corpus, words corresponding to the tags of the subset of the third sequence of tags as the revised subset of words.

In some implementations, adjusting the sequence of words to a revised sequence of words can include replacing one or more words of the sequence of words as well as rearranging one or more words. In some implementations, replacing one of the words with another word may include replacing the word with a similar word. In some implementations, the grammar corrector can adjust the sequence of words with the revised sequence of words such that a revised sequence of tags based on the revised sequence of words matches the third sequence of tags. To do so, the grammar corrector can identify words that match the tags of the third sequence of tags and compare the identified words with the sequence of words identified as having the grammatical error. The grammar corrector can then replace the identified words with the sequence of words.

The writing analyzer can be configured to provide the revised sequence of words for display. In some implementations, the writing analyzer can provide a marked up version of the sequence of words that identifies differences between the sequence of words and the revised sequence of words.

The tag module 224 may comprise one or more applications, programs, libraries, services, processes, scripts, tasks or any type and form of executable instructions executing on one or more devices, and can be designed, constructed or configured to tag each word in a sequence of words. The tag module 224 can associate one or more tags with each word in the sequence of words. The tag module 224 can be configured to identify a word, perform a lookup in a database of the word and identify one or more tags associated with the word. In some implementations, the grammar correction system 210 can maintain one or more databases that include a list of words and a list of corresponding tags with which each of the words can be associated. In some implementations, each word is also associated with one or more root words such that tags associated with the root word may also be associated with the word. The tag module can be configured to implement part of speech tagging to tag each word with an appropriate part of speech tag identifying the possible parts of speech the word may be. It should be appreciated that some words can correspond to multiple parts of speech. In some implementations, the tag module 224 can be configured to identify the part of speech of a particular word based on the adjoining words. In some implementations, the tag module 224 can be configured to tag the word with multiple parts of speech by simply performing a lookup without analyzing the context in which the word is used. Other tags can be used to identify if a word is singular or plural, a subject or a verb, a future tense, present tense or past tense, a number, amongst others. Examples of some tags include “N” for noun, “V” for verb, “AJ” for adjective, “AUX” for modal auxiliary verbs such as can, should, and might, “PRO” for pronouns, “QUL” for qualifiers, amongst others. An example of a more sophisticated tag can be “Bee3srx”, which can be associated with the word “is” and can indicate that the word “is” is related to the verb “to be” (Bee), is third-person (3) singular (s), present (r), and is not negative (x).

In some implementations, the tag module 224 can be configured to tag each of the words included in the sequence of words. In some implementations, the tag module can be configured to first parse the sequence of words and identify words that match words included in a primary list of words. The primary list of words include words that have one or more tags that are unique to the grammar correction system 210. These words can be words that have been identified as being incorrectly or improperly tagged in typical tagging algorithms or dictionaries that are publicly available. The tag module 224 can then tag each of the words that do not match words included in the primary list of words using an open source software dictionary or tagging algorithm publicly available via the Internet. In some implementations, the tag module 224 can then perform a check to ensure that each of the words tagged by the tag module 224 are correctly tagged based on the surrounding grammatical and lexical contexts. That is, the tag module can check to identify, for example, one or more words that may have different parts of speech, are tagged with the appropriate part of speech based on the surrounding words.

In some implementations, the grammar correction system 210 can be configured to inspect the words in a writing for spelling mistakes prior to the tag module 224 tagging words. In this way, any words that are misspelt can be corrected prior to being tagged. The grammar correction system may not be able to correctly identify the correct spelling of a misspelt word as the misspelt word may correspond to one of many possible words. In some such implementations, the tag module 224 can be configured to tag the misspelt word as if the misspelt word was each of the many possible words. In some implementations, the grammar correction module can be configured to identify the most suitable word corresponding to the misspelt word based on the context in which the misspelt word was being used. In some such implementations, the misspelt word can be replaced with the most suitable word and the tag module 224 can be configured to associate the most suitable word with one or more tags that correspond to the most suitable word.

The rule module 226 may comprise one or more applications, programs, libraries, services, processes, scripts, tasks or any type and form of executable instructions executing on one or more devices, and can be designed, constructed or configured to create and implement one or more rules. The rules may be error-based rules. In some implementations, the rule module can be configured to identify an error in a sequence of words if the sequence of words matches a condition defined in the error-based rule. In some implementations, the rule module 226 may identify an error if the tags associated with the sequence of words matches a condition defined in the error-based rules. In some implementations, the rules may be grammar-based rules. In some implementations, the rule module can be configured to identify an error in a sequence of words if the sequence of words does not match a condition defined in one or more grammar-based rules. Examples of error-based rules are subject-verb agreement, possessive pronoun agreement, verb complement error, and compound verb detection.

In some implementations, the rule module 226 can manage one or more rules. The rule module can be configured to maintain a rules database in which one or more rules are stored. The rule module can be configured to select an order in which one or more of the rules are to be applied. In some implementations, the rule module 226 can apply the rules to the writing sequentially. That is, the rule module 226 may inspect the writing against a first rule and upon determining that there are no grammatical errors detected by the first rule, may inspect the writing against a second rule. The order in which the first rule and the second rule are applied can be determined by the rule module 226. In some implementations, the rule module 226 can be configured to determine the order in which the rules are applied based on one or more factors, including but not limited to, demographic information of the writer, the writer's previous writing analysis, the type of writing, amongst others. It has been found that writers belonging to a certain demographic are likely to make the same or similar grammatical mistakes. Examples of demographic information can include a writer's native language, a writer's country of origin, a writer's age, a writer's gender, amongst others. This is particularly true for writers writing in a language that is not their native language. In some implementations, writers of a particular race or geographic region may make the same types of grammatical mistakes. In some such implementations, the rule module 226 may be configured to arrange the order in which the rules are to be applied based on the demographic information of the writer.

In an effort to improve efficiency of the grammar correction system, the rule module 226 can be configured to select an order in which the rules are to be applied. In some implementations, the rule module 226 can determine which rules are likely to detect more grammatical errors based on the writer's demographic information. The rule module 226 may then arrange the order in which the rules are to be applied such that rules that are likely to detect more grammatical errors than other rules are to be applied before the other rules. In some implementations, the rule module can be configured to determine which rules are likely to detect more grammatical errors based on the writer's previous writing analysis. A writer is more prone to repeating the same grammatical mistakes and therefore, rules that identified the most number of errors in a previous writing analysis can be applied before rules that are less likely to detect more grammatical errors based on the writer's previous writing analysis.

The rule module 226 can further be configured to create error-based rules as the rule module 226 identifies one or more grammatical errors. In some implementations, each time the rule module 226 identifies an error, the rule module 226 can be configured to create an error-based rule corresponding to the identified error. In this way, the rule module 226 can build a database of error-based rules that is continuously evolving as more and more writings are analyzed.

In some implementations, the rule module 226 can be configured to apply the rules simultaneously instead of applying the rules sequentially. In some such implementations, one or more of the rules may be conditional upon other rules. In such implementations, rules that are conditional upon other rules can be applied after applying the rules upon which the rules are conditioned. In some implementations, the rule module 226 can be configured to apply a first set of rules simultaneously and a second set of rules sequentially.

The rule module 226 can be configured to create rules that are based on one or more tags. In some implementations, the rule module 226 can inspect a writing by analyzing the tags associated with the words and determining if the tags correspond to one or more rules. In some implementations, the rule module 226 can identify an error if the tags associated with words of a sequence of words match a condition defined in an error-based rule. In some implementations, the rule module 226 can identify an error if the tags associated with words of a sequence of words do not match a condition defined in a grammar-based rule. In some implementations, the rule module 226 can identify an error if the tags associated with words of a sequence of words do not match any condition defined in any of the grammar-based rules applied by the rule module 226.

The user profile manager 228 may comprise one or more applications, programs, libraries, services, processes, scripts, tasks or any type and form of executable instructions executing on one or more devices, and can be designed, constructed or configured to generate and manage user profiles. A user profile is a collection of information associated with a user of the grammar correction system. In some implementations, the user can be a writer that has provided one or more pieces of writing for review. In some implementations, the user profile can include demographic information of the user, including but not limited to the user's native language, the user's country of origin, the user's current geographic location, the user's age, gender, past writing analysis, profession, amongst others. The past writing analysis of the user can include a list of the type and frequency of errors a user makes in a writing, the user's writing style, the user's previous writing score, the type of documents the user writes or submits, amongst others. In some implementations, the user profile manager 228 may receive information associated with the user from the user. In some implementations, the user profile manager 228 may receive information associated with the user from one or more social networking accounts of the user.

The score analyzer 230 may comprise one or more applications, programs, libraries, services, processes, scripts, tasks or any type and form of executable instructions executing on one or more devices, and can be designed, constructed or configured to analyze a score for a writing. The score analyzer 230 can be configured to analyze characteristics of the writing, including the length of the writing, for example, the number of words in the writing, the level of language used in the writing, the number of errors identified in the writing, the frequency and type of such errors, amongst others. In addition, the score analyzer 230 may also be configured to analyze information associated with the writer, including the writer's age, length of time writing a particular language, amongst others. The score analyzer 230 can be configured to determine a score of the writing based on the characteristics of the writing. In some implementations, the score analyzer 230 can be configured to determine a score of the writing based in part on the information associated with the writer. The score can be based on a numerical scale or on a qualitative scale corresponding to a numerical scale. For example, the score can be based on a numerical scale between 0-10. In some implementations, the score can be based on a qualitative scale from “poor” to “excellent.” In some implementations, the qualitative scale can correspond to a numerical scale.

The score analyzer can be configured to determine a score based in part on the type and frequency of errors a writer makes. In addition, the score analyzer can be configured to determine the score based in part on the type of errors the writer does not make. The score analyzer can be configured to track the writer's performance over a series of writings and to gauge the writer's progress. The score analyzer can be configured to generate a score chart indicating the writer's progress. The score chart can include information identifying the types of errors being made, the frequency in which they are made, as well as information related to previous writings. In some implementations, the score chart can identify a list of errors the writer made in previous writings and a list of errors the writer made in a present writing. The score analyzer can automatically identify the differences in the types and frequency of errors and generate a score corresponding to the differences.

In some implementations, the score may be based in part on the writer's demographic information. The score may indicate the writer's competence in writing relative to other writer's sharing the same or similar demographic information. This is because non-native writers may struggle to compete against native writers and therefore, their level of competence may be gauged relative to writers of the same native language or country of origin.

The user interface manager 232 may comprise one or more applications, programs, libraries, services, processes, scripts, tasks or any type and form of executable instructions executing on one or more devices, and can be designed, constructed or configured to provide a user interface through which a user can communicate with the grammar correction system. In particular, the user interface can be configured to receive a writing from a user and provide a revised version of the writing for display.

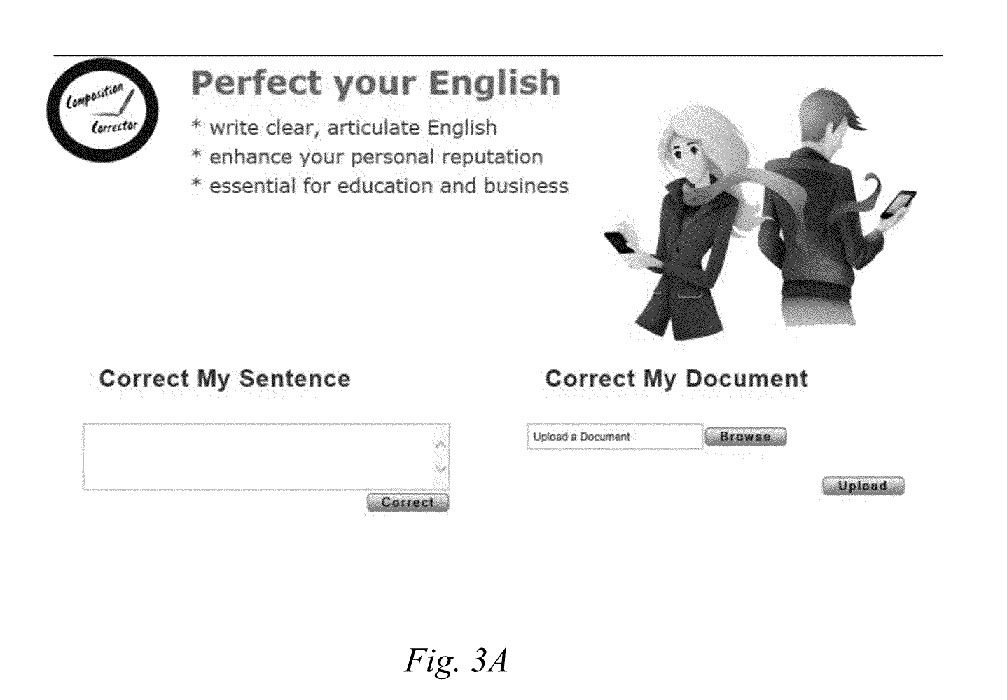

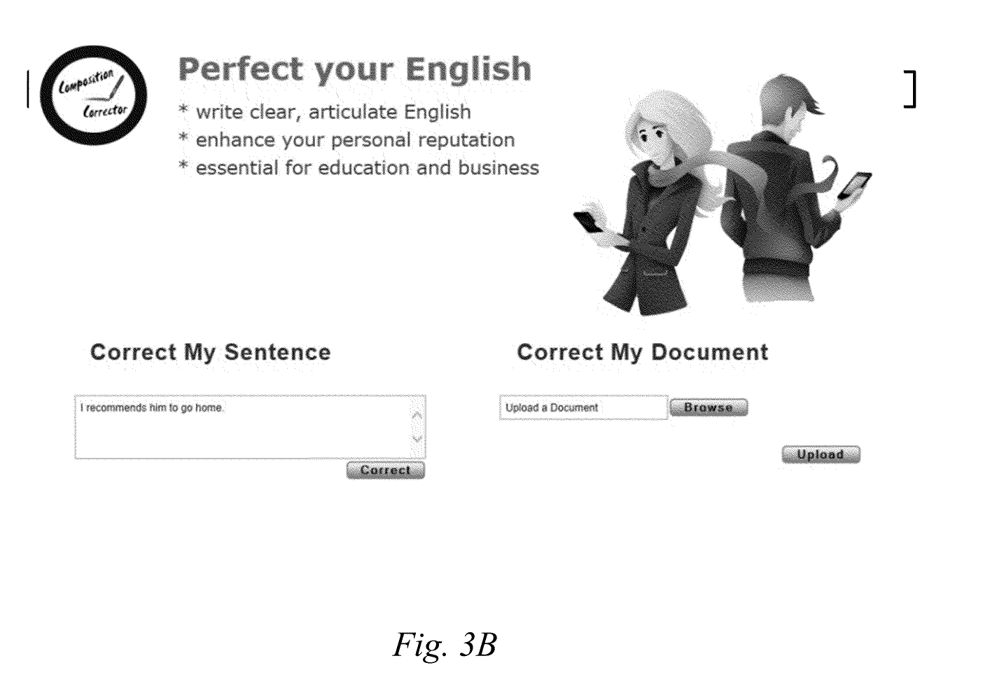

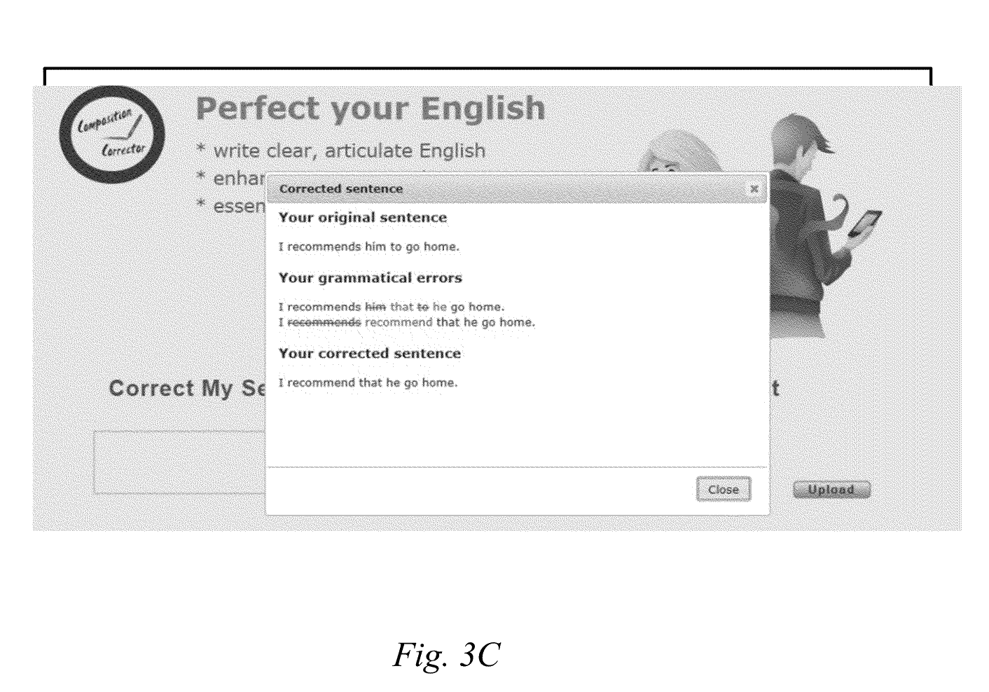

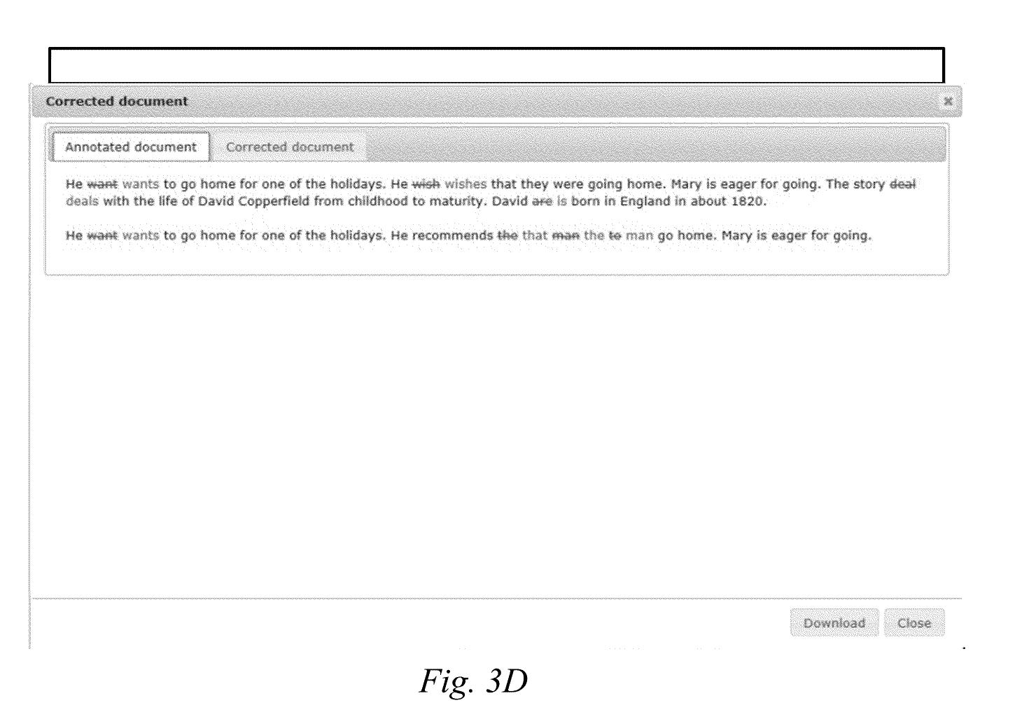

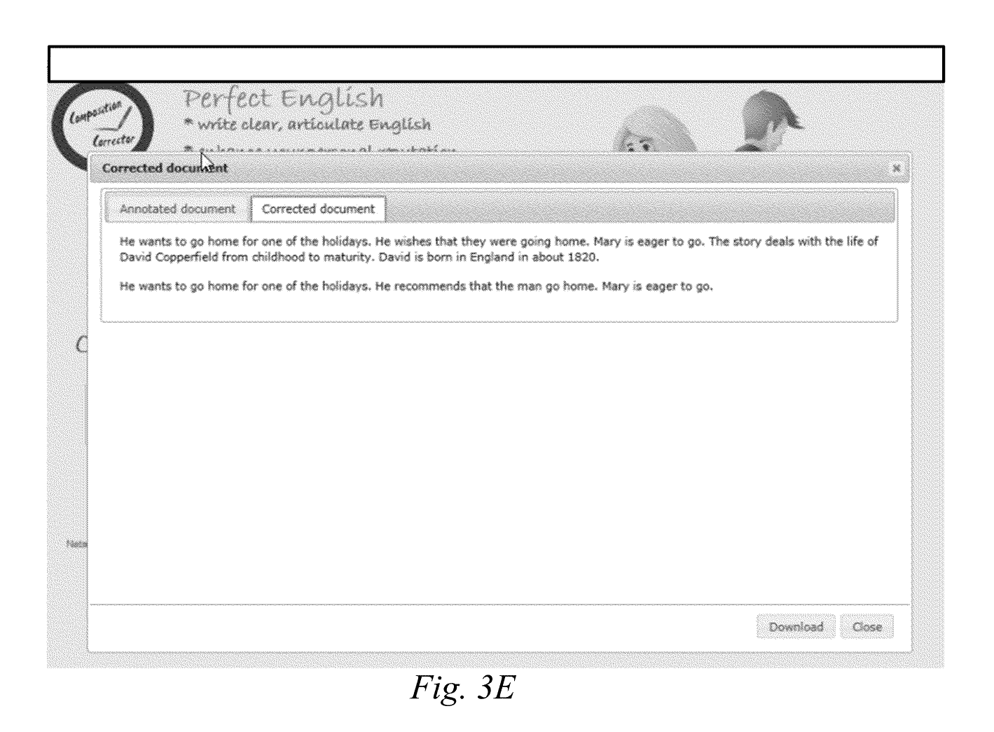

FIGS. 3A-3E are a sequence of screenshots of a user interface through which users can submit written text and view identified grammatical errors and corrections in accordance with one or more embodiments. FIG. 3A shows a screenshot of the user interface in which a user can insert a writing within an input box or can upload a document including a writing. FIG. 3B shows a screenshot of the user interface in which a user has inserted a sentence within the input box. FIG. 3C shows a screenshot of the user interface displaying both the original sentence inserted by the user and a corrected version of the original sentence. FIG. 3D shows a screenshot of the user interface displaying an annotated version of a writing from a document uploaded for review. FIG. 3E shows a screenshot of the user interface displaying a corrected version of a writing from a document uploaded for review. In some implementations, the user interface can allow a user to switch between an annotated version of the document and a corrected version of the document. In this way, a user can seamlessly view the annotated version and the corrected version of the same document by a single user action, such as a click. In some implementations, the user interface can allow a user to download the annotated version of the document. In some implementations, the user interface can allow a user to download the corrected version of the document.

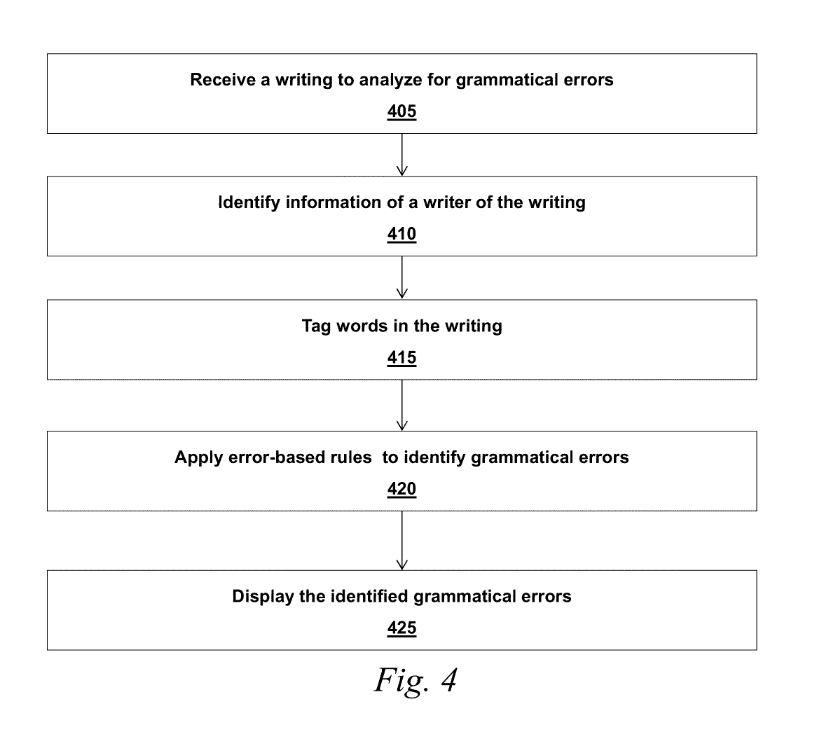

FIG. 4 is a block diagram illustrating a flow of a method for improving the probability of grammatical error detection. In brief overview, the method includes receiving a writing to analyze for grammatical errors (step 405), identifying information of a writer of the writing (step 410), tagging words in the writing (step 415), applying error-based rules to identify grammatical errors (step 420) and displaying the identified grammatical errors (step 425).

In further detail, a writing to be analyzed for grammatical errors is received (step 405). The grammar correction system can receive a writing via a user interface through which the user can submit the writing for analysis. In some implementations, the user can provide the writing to the grammar correction system by inserting the writing to be analyzed in a text box provided by the user interface or by uploading a document containing the writing via the user interface. In some implementations, the grammar correction system can be configured to analyze writings by crawling webpages and identifying text. In some such implementations, the grammar correction system can be configured to analyze the writings to determine a score indicating the quality of the writing. In some implementations, the grammar correction system can serve as a plugin or add-on to a web browser or other word processing application. In some such implementations, the grammar correction system can be configured to receive a writing to be analyzed via one or more user actions, including but not limited to selecting a portion of text and selecting an icon on the web browser or application to provide the selected portion of text to the grammar correction system.

The grammar correction system can identify information of a writer of the writing (step 410). In some implementations, the grammar correction system can identify a writer of the writing. The grammar correction system can then receive, retrieve or collect information of the writer. Examples of the information the grammar correction system can retrieve or receive includes demographic information of the writer, for example, the writer's native language, country of origin, age, gender, profession, writer's declared or previously determined level of competency, education level, current location, amongst others. In addition, the grammar correction system can retrieve or receive other information associated with the writer, including but not limited to the user's previous writings. These can include writings received by the grammar correction system or other writings associated with the user but not previously received by the grammar correction system. The grammar correction system can utilize information of the writer to predict the types of errors the writer is likely to make and the frequency at which the writer will likely make the errors.

The grammar correction system can tag words in the writing (step 415). In some implementations, the grammar correction system can be configured to identify words in the writing and tag each of the words in the writing. In some implementations, the grammar correction system can be configured to first analyze the writing for spelling mistakes prior to analyzing the writing for grammatical errors. In doing so, the grammar correction system can be configured to tag each of the words that appears to be misspelt with special tags to indicate that the word is possibly misspelt. The grammar correction system can determine if a word is misspelt if the word does not match a list of words in a corpus, for example, one or more dictionaries or databases. In some implementations, the grammar correction system can tag each word with one or more tags. In some implementations, the tags can correspond to parts-of-speech tags.

The grammar correction system can utilize error-based rules to identify grammatical errors in the writing (step 420). In some implementations, the error-based rules can include one or more tags which when combined or arranged in a certain way identify an error. The grammar correction system can inspect tags associated with words to determine if tags associated with a sequence of words are arranged in a manner that matches the arrangement of tags defined by one of the error-based rules. In some implementations, the grammar correction system can utilize grammar-based rules to identify grammatical errors in the writing. Grammar-based rules can include one or more tags which when combined or arranged in a certain way identify that the grammar of the writing does not violate the particular grammar-based rule. In some implementations, the grammar correction system can identify an error if the tags associated with words of a sequence of words do not match any condition defined in any of the grammar-based rules applied by the grammar correction system.

In some implementations, the grammar correction system can be configured to determine the order in which one or more rules are applied to identify grammatical errors. In some implementations, the grammar correction system can be configured to utilize information associated with the writer to determine the order in which the rules are applied. In this way, based on the predicted tendencies of the writer, which are based in part on the writer's demographic information and his previous writing analysis by the grammar correction system, the grammar correction system can determine the order in which the rules are applied to identify grammatical errors in the writing.

The grammar correction system can display the identified grammatical errors. In some implementations, the grammar correction system can display the identified grammatical errors and provide appropriate corrections to the identified grammatical errors. In some implementations, the grammar correction system can be configured to identify the rule that triggered the identification of the grammatical error.

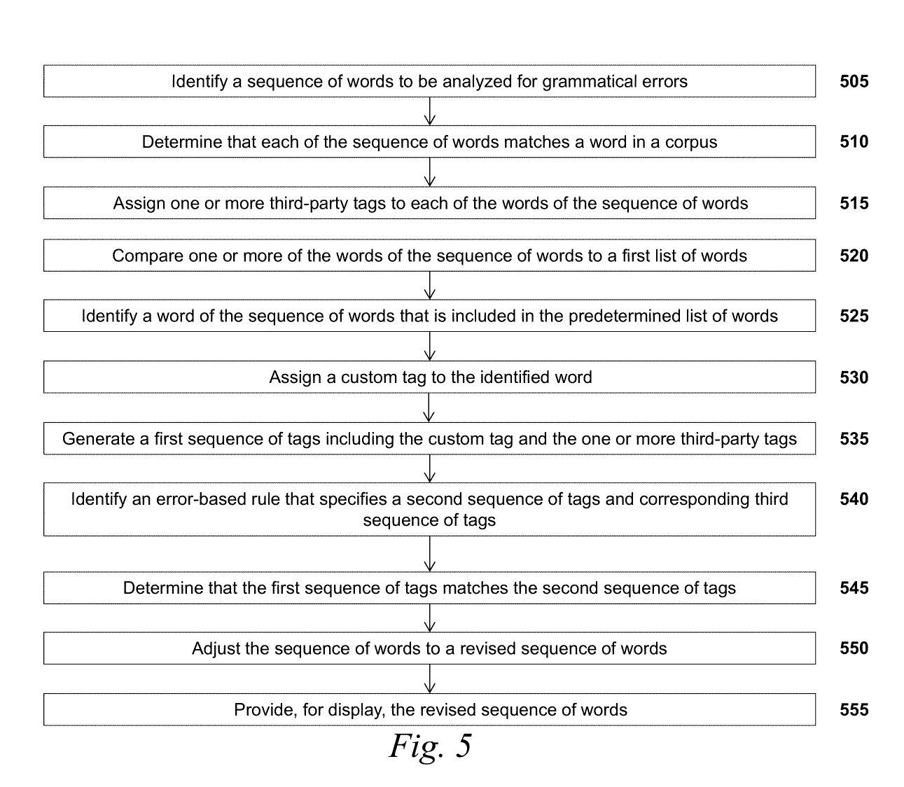

FIG. 5 is a block diagram illustrating a flow of a method for detecting grammatical errors in a sequence of words using a set of error detection rules. In brief overview, a grammatical checker configured on a device including one or more processors identifies word data representing a sequence of words to be analyzed for grammatical errors (BLOCK 505). The grammatical checker determines that each of the sequence of words matches a word in a corpus represented by corpus data stored on the device (BLOCK 510). A third-party tagging system configured on the device assigns one or more third-party tags to each of the words of the sequence of words (BLOCK 515). The device stores, for each of the words, the one or more third-party tags assigned to the word with the word. The grammatical checker compares one or more of the words of the sequence of words to a predetermined list of words to be tagged using custom tags instead of third-party tags (BLOCK 520). The grammatical checker identifies, based on the comparison, a word of the sequence of words that is included in the predetermined list of words (BLOCK 525). A first tagging system configured on the device assigns a custom tag to the identified word (BLOCK 530). The device stores the custom tag with the identified word. The grammatical checker generates a first sequence of tags including the custom tag and the one or more third-party tags (BLOCK 535). The sequence of tags is arranged in the order of the words in the sequence of words. The grammatical checker identifies an error-based rule that specifies a second sequence of tags representative of a grammatical error and corresponding third sequence of tags representative of a correction of the grammatical error of the second sequence of tags (BLOCK 540). The device stores the second sequence of tags and the third sequence of tags. The grammatical checker determines that the first sequence of tags matches the second sequence of tags of the error-based rule (BLOCK 545). Responsive to determining that the first sequence of tags matches the second sequence of tags of the error-based rule, a grammatical corrector configured on the device adjusts the sequence of words to a revised sequence of words such that a revised sequence of tags based on the revised sequence of words matches the third sequence of tags (BLOCK 550). The device then provides, for display, the revised sequence of words (BLOCK 555).

In further detail, the grammatical checker can receive or identify word data representing a sequence of words to be analyzed for grammatical errors (BLOCK 505). In some implementations, the grammatical checker can receive a document including the sequence of words. In some implementations, the grammatical checker can crawl the web to identify one or more web documents to inspect for grammatical errors. In some implementations, the sequence of words is a part of a web document crawled by the grammatical checker. In some implementations, the document can be received from a user via a user interface.

The grammatical checker can be configured to determine that each of the sequence of words matches a word in a corpus represented by corpus data stored on the device (BLOCK 510). In some implementations, the corpus can be one or more dictionaries. In some implementations, the corpus can be any list of words. In some implementations, the corpus data can be stored on the grammar correction system. In some implementations, the corpus data can be stored remote the grammar correction system but may be accessible by the grammar correction system. In some implementations, the corpus data may be stored on the grammar correction system when being accessed by the grammar correction system.

The grammatical checker can be configured to determine that each word of the sequence of words matches a word in the corpus. If a word of the sequence of words does not match any of the words included in the corpus, the grammatical checker may determine that the word is misspelt. In some implementations, the grammatical checker may determine that a word matches a word in the corpus by identifying each character or letter of the word and determining a position of the character of the word relative to the other characters of the word.

The grammatical checker can then compare the word with each of the words in the corpus. To compare the word with words in the corpus, the grammatical checker can identify a first character of the word, identify words in the corpus that begin with the same character. The grammatical checker can then recursively check for the next character of the word, from the identified words in the corpus, a subset of the words that have a next character that matches the next character of the word. The grammatical checker can determine that the word does not match a word in the corpus if the sequence of characters of the word do not match a complete sequence of characters of any word in the corpus.

The grammatical checker can be configured to assign, to the word, a tag specifying that the word is misspelt responsive to determining that the word does not match any word in the corpus. The grammatical checker can be configured to identify words similar to the misspelt word based on a comparison of the characters of the misspelt word and words in the corpus. In some implementations, the grammatical checker can be configured to identify the sequence of words to understand the grammatical context of the misspelt word to identify a word that can replace the misspelt word. In some implementations, to determine the word that can replace the misspelt word, the grammatical checker may be configured to apply one or more tags to each of the words in the sequence and determine, based on one or more rules for detecting errors, an appropriate tag to be associated with the misspelt word. Based on the tag of the misspelt word as well as the characters of the misspelt word, the grammatical checker can be configured to identify the word in the corpus that would be a suitable replacement for the misspelt word.

A third-party tagging system configured on the grammar correction system can assign one or more third-party tags to each of the sequence of words (BLOCK 515). The grammar correction system may store, for each word of the sequence of words, the one or more third-party tags with the corresponding word in memory. In some implementations, the third-party tagging system may utilize one or more third-party tagging tools for tagging the words. The third-party tagging tools may be available online. In some implementations, a database including a plurality of words and corresponding third-party tags may be stored on the grammar correction system. In some implementations, the grammar correction system can employ more than one third-party tagging system. In some such implementations, the grammar correction system can select tags of a particular third-party tagging system for certain words and select tags of another third-party tagging system for other words.

The grammatical checker can be configured to compare one or more of the words of the sequence of words to a predetermined list of words to be tagged using custom tags instead of third-party tags (BLOCK 520). In some implementations, the grammatical checker can maintain a predetermined list of words that third-party tagging systems tag incorrectly or improperly such that third-party systems that detect errors are unable to detect errors caused in part by the use of the word in the sequence of words. Each word in the predetermined list of words can have one or more custom tags specific to the word that may be assigned by a first tagging system instead of a third-party system.

The grammatical checker can identify, based on the comparison of one or more of the sequence of words with the predetermined list of words, a word of the sequence of words that is included in the predetermined list of words (BLOCK 525). An example of such a word is the word “is.”

A first tagging system configured on the grammar correction system can assign a custom tag to the word of the sequence of words that is identified to match a word in the predetermined list of words (BLOCK 530). The grammar correction system may store the custom tag with the identified word in memory. In some implementations, the first tagging system may identify a custom tag to assign to the word based on a lookup of the word in a database that includes a plurality of words and custom tags associated with the plurality of tags. In some implementations, the database may be stored on the grammar correction system. In some implementations, the custom tags assigned to the word that is included in the predetermined list of words may be based on a combination of a part-of-speech tag, a singular or plural tag and a tense tag. An example of a custom tag can be “Bee3srx”, which can be associated with the word “is” and can indicate that the word “is” is related to the verb “to be” (Bee), is third-person (3) singular (s), present (r), and is not negative (x).

In some implementations in which the grammatical checker determines that the sequence of words includes a misspelt word, the grammatical checker can determine, based on comparing characters of the misspelt word, that the misspelt word is similar to one or more words of the corpus, identify tags associated with each of the one or more words of the corpus to which the misspelt word is similar, assign the misspelt word a custom tag indicating that the word is misspelt and assign the misspelt word one or more tags based on the words of the corpus to which the misspelt word is similar.

The grammatical checker may be configured to generate a first sequence of tags including the custom tag and the one or more third-party tags (BLOCK 535). The grammatical checker may arrange the tags in the sequence of tags in the order of the words in the sequence of words such that all tags associated with a first word in the sequence of words may correspond to a first position in the sequence of tags and all tags associated with a second word in the sequence of words may correspond to a second position in the sequence of tags and so on. In some implementations, the grammatical checker may generate tag data representing the first sequence of tags.

The grammatical checker may be configured to identify one or more error-based rules (BLOCK 540). Each of the error-based rules can be used to identify one or more grammatical errors in a sequence of words by comparing the sequence of tags generated from the sequence of words with a predetermined sequence of tags identified to be associated with a grammatical error. In some implementations, an error-based rule can specify a second sequence of tags representative of a grammatical error. That is, if words corresponding to the second sequence of tags were arranged in a sequence based on the second sequence of tags, the sequence of words would include a grammatical error. The error-based rule can also specify a corresponding third sequence of tags that is representative of a correction of the grammatical error of the second sequence of tags. That is, if words corresponding to the third sequence of tags were arranged in a sequence based on the third sequence of tags, the sequence of words would be grammatically correct. In some implementations, the grammar correction system can store the second sequence of tags and the third sequence of tags for each of the error-based rules.

The grammatical checker can be configured to determine that the first sequence of tags matches the second sequence of tags of the error-based rule (BLOCK 545). To do so, the grammatical checker can identify the tags of the first sequence of tags corresponding to the first word of the sequence of words and check if these tags match the first set of tags of the second sequence of tags. In some implementations, a plurality of tags can be combined to form a combination tag and as such, each word may be represented by a single tag that is a combination of multiple tags. If all of the tags of the first sequence of tags matches all of the tags of the second sequence of tags, the grammatical checker can be configured to determine that the first sequence of words includes a grammatical error.

A grammar corrector configured on the grammar correction system can, responsive to determining that the first sequence of tags matches the second sequence of tags of the error-based rule, adjust the sequence of words to a revised sequence of words (BLOCK 550). In some implementations, adjusting the sequence of words to a revised sequence of words can include rearranging the words in the sequence of words or replacing words in the sequence of words with other words.

In some implementations, to adjust the sequence of words to a revised sequence of words, the grammar corrector can identify, based on a comparison of the first sequence of tags and the third sequence of tags, a subset of tags of the first sequence of tags that are different from a corresponding subset of the third sequence of tags. The grammar corrector can then identify a subset of words of the sequence of words corresponding to the subset of tags. The grammar corrector can then replace the subset of words with a revised subset of words from the corpus that when assigned tags, match the subset of the third sequence of tags. In some implementations, replacing the subset of words with a revised subset of words include identifying the tags of the subset of the third sequence of tags and identifying, from the corpus, words corresponding to the tags of the subset of the third sequence of tags as the revised subset of words.

In some implementations, adjusting the sequence of words to a revised sequence of words can include replacing one or more words of the sequence of words as well as rearranging one or more words. In some implementations, replacing one of the words with another word may include replacing the word with a similar word. In some implementations, the grammar corrector can adjust the sequence of words with the revised sequence of words such that a revised sequence of tags based on the revised sequence of words matches the third sequence of tags. To do so, the grammar corrector can identify words that match the tags of the third sequence of tags and compare the identified words with the sequence of words identified as having the grammatical error. The grammar corrector can then replace the identified words with the sequence of words.

The grammar correction system can be configured to provide the revised sequence of words for display (BLOCK 555). In some implementations, the grammar correction system can provide a marked up version of the sequence of words that identifies differences between the sequence of words and the revised sequence of words.

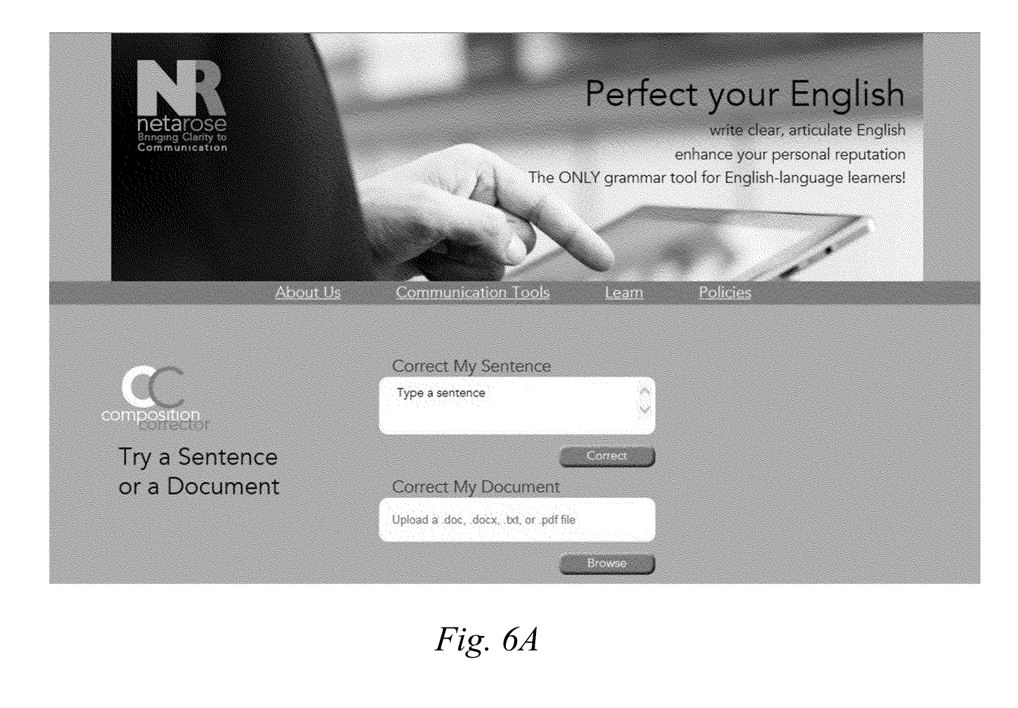

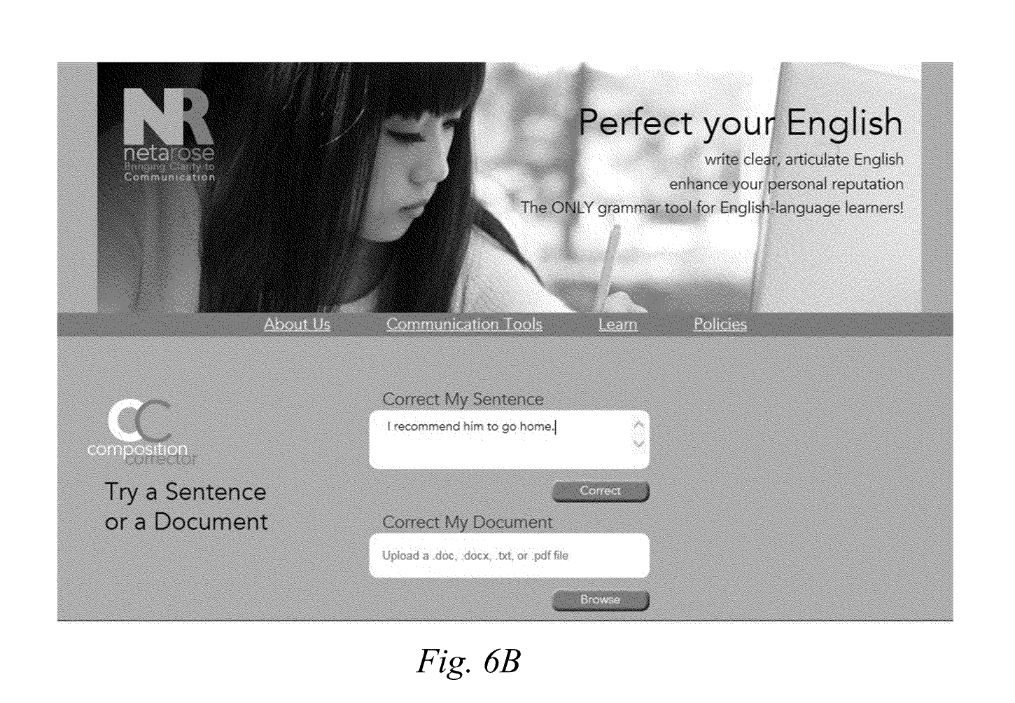

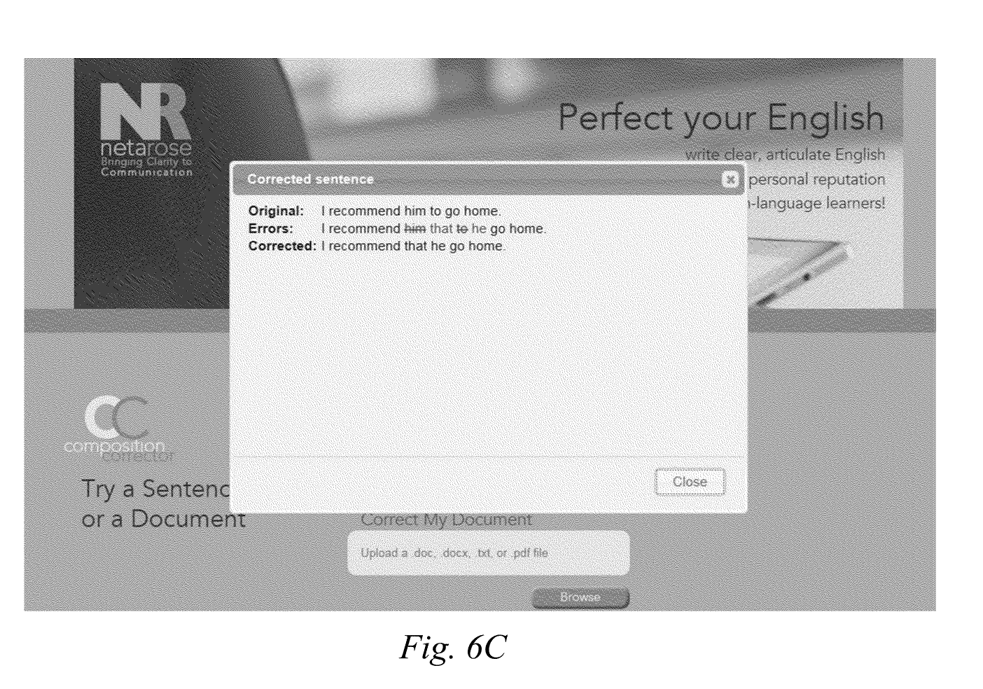

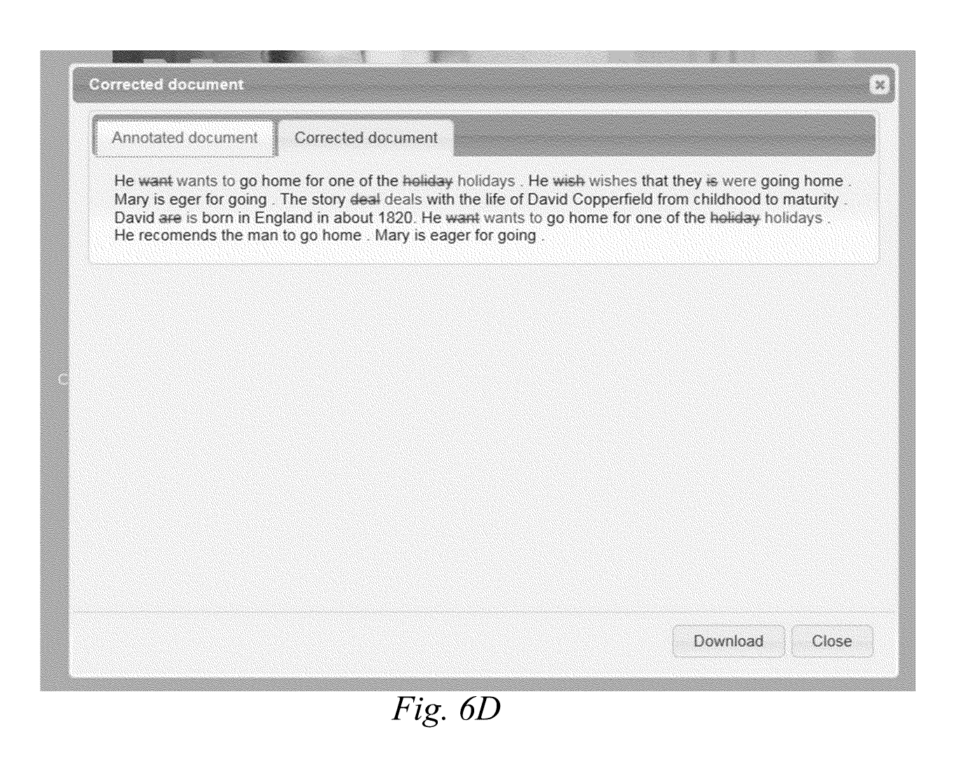

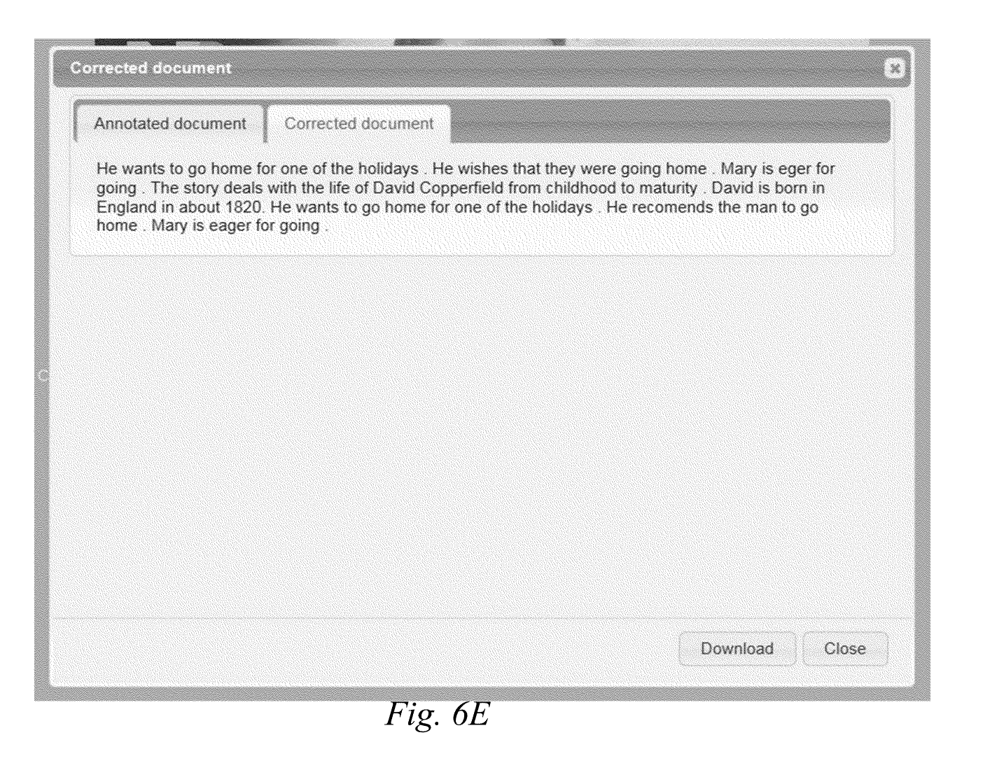

FIGS. 6A-6E are a sequence of screenshots of a user interface through which users can submit written text and view identified grammatical errors and corrections in accordance with one or more embodiments. FIG. 6A shows a screenshot of the user interface in which a user can insert a writing within an input box or can upload a document including a writing. FIG. 6B shows a screenshot of the user interface in which a user has inserted a sentence within the input box. FIG. 6C shows a screenshot of the user interface displaying both the original sentence inserted by the user and a corrected version of the original sentence. FIG. 6D shows a screenshot of the user interface displaying an annotated version of a writing from a document uploaded for review. FIG. 6E shows a screenshot of the user interface displaying a corrected version of a writing from a document uploaded for review. In some implementations, the user interface can allow a user to switch between an annotated version of the document and a corrected version of the document. In this way, a user can seamlessly view the annotated version and the corrected version of the same document by a single user action, such as a click. In some implementations, the user interface can allow a user to download the annotated version of the document. In some implementations, the user interface can allow a user to download the corrected version of the document.

### C. Systems and Methods of Evaluating a Writer's Level of Competence in a Natural Language

The grammar correction system can be configured to evaluate a user's level of competence in a natural language. In particular, the grammar correction system can be configured to quantify a writer's level of competence in a natural language by implementing a weighting scheme based on the number and types of grammatical errors the writer makes. In some implementations, the grammar correction system can be configured to identify and analyze the grammatical errors in the writer's writing. In particular, the grammar correction system can be configured to determine the type of grammatical error for each identified error and identify a frequency of each type of grammatical error. The grammar correction system can be configured to compute a competency score based in part on the frequency of each type of grammatical error made by the writer. In some implementations, the grammar correction system can be configured to further identify one or more reasons justifying the determined level of competence and provide one or more suggestions to help improve the writer's level of competence.

By determining a writer's level of competence in a natural language, the grammar correction system can be able to provide valuable feedback to a writer regarding the writer's progress in learning a language as well as provide the writer an indication of the writer's level of competence relative to other writers. Oftentimes, the level of competence of a writer can affect other people's perceptions of the writer. In some instances, people perceive the reputation of a website or business based on the writings included in the website or associated with the business. For example, a user looking to purchase a product or service online may be more inclined to purchase the product or service from a website that does not have typographical or grammatical errors on the website. Such types of errors are perceived by users as unprofessional and may convince users that the website may not be as reliable as a website having no grammatical errors.

In some implementations, the score analyzer 230 (FIG. 2B) of the grammar correction system can be configured to determine a competency score of a writer indicating a level of competence of the writer in a natural language based on one or more writings associated with the writer. The score of the writer can correspond to the writer's level of competence in a particular natural language. The score analyzer 230 can be configured to monitor the writer's writing history and determine a writer's score based in part on the number of writings, the recency of each of the writings, the type and frequency of errors made in each of the writings, the level of each of the writings, amongst others. In some implementations, the score analyzer can be configured to assign a weight to each of the writings according to the recency of the writing. As such, the score analyzer can assign a greater weight to more recent writings as compared to older writings.

In some implementations, the score analyzer 230 can be configured to compute a writer's level of competence by analyzing one or more writings of the writer and comparing selected sequence of words, for example, sentences, against one or more predetermined set of rules. Based on the type and number of errors identified in the selected sequence of words against the predetermined set of rules, the score analyzer 230 can compute a competency score for the writer.

While the invention has been particularly shown and described with reference to specific embodiments, it should be understood by those skilled in the art that various changes in form and detail may be made therein without departing from the spirit and scope of the invention described in this disclosure.

While this specification contains many specific embodiment details, these should not be construed as limitations on the scope of any inventions or of what may be claimed, but rather as descriptions of features specific to particular embodiments of particular inventions. Certain features described in this specification in the context of separate embodiments can also be implemented in combination in a single embodiment. Conversely, various features described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated in a single software product or packaged into multiple software products.

References to “or” may be construed as inclusive so that any terms described using “or” may indicate any of a single, more than one, and all of the described terms.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain embodiments, multitasking and parallel processing may be advantageous.

What is claimed is:

1. A method for detecting grammatical errors in a sequence of words using a set of error detection rules comprises:
identifying, by a grammatical checker configured on a device including one or more processors, word data representing a sequence of words to be analyzed for grammatical errors;
determining, by the grammatical checker, that each word of the sequence of words matches a word in a corpus represented by corpus data stored on the device;
assigning, by a third-party tagging system configured on the device, one or more third-party tags to each of the words of the sequence of words, the device storing, for each of the words, the one or more third-party tags assigned to the word with the word;
comparing, by the grammatical checker, one or more of the words of the sequence of words to a predetermined list of words to be tagged using custom tags instead of third-party tags;
identifying, by the grammatical checker, based on the comparison, a word of the sequence of words that is included in the predetermined list of words;
assigning, by a first tagging system configured on the device, a custom tag to the identified word, the device storing the custom tag with the identified word and removing the third-party tags assigned to the identified word;
generating, by the grammatical checker, a first sequence of tags including the custom tag and the one or more third-party tags, the sequence of tags arranged in the order of the words in the sequence of words;
identifying, by the grammatical checker, an error-based rule that specifies a second sequence of tags representative of a grammatical error and corresponding third sequence of tags representative of a correction of the grammatical error of the second sequence of tags, the device storing the second sequence of tags and the third sequence of tags;
determining, by the grammatical checker, that the first sequence of tags matches the second sequence of tags of the error-based rule;
responsive to determining that the first sequence of tags matches the second sequence of tags of the error-based rule, adjusting, by a grammatical corrector configured on the device, the sequence of words to a revised sequence of words such that a revised sequence of tags based on the revised sequence of words matches the third sequence of tags; and
providing, for display, the revised sequence of words.

2. The method of claim 1, wherein identifying the word data representing a sequence of words to be analyzed for grammatical errors includes receiving a document including the sequence of words to be analyzed for grammatical errors.

3. The method of claim 1, further comprising:
determining, by the grammatical checker, that a misspelt word of the sequence of words does not match any word in the corpus;
determining, based on comparing characters of the misspelt word, that the misspelt word is similar to one or more words of the corpus;
identifying tags associated with each of the one or more words of the corpus to which the misspelt word is similar;
assigning the misspelt word a custom tag indicating that the word is misspelt; and
assigning the misspelt word one or more tags based on the words of the corpus to which the misspelt word is similar.

4. The method of claim 1, wherein the custom tags assigned to the word that is included in the predetermined list of words are based on a combination of a part-of-speech tag, a singular or plural tag and a tense tag.

5. The method of claim 1, wherein adjusting the sequence of words to a revised sequence of words includes:
identifying, based on a comparison of the first sequence of tags and the third sequence of tags, a subset of tags of the first sequence of tags that are different from a corresponding subset of the third sequence of tags;
identifying a subset of words of the sequence of words corresponding to the subset of tags; and
replacing the subset of words with a revised subset of words from the corpus that when assigned tags, match the subset of the third sequence of tags.

6. The method of claim 5, wherein replacing the subset of words with a revised subset of words includes:
identifying the tags of the subset of the third sequence of tags;
identifying, from the corpus, words corresponding to the tags of the subset of the third sequence of tags as the revised subset of words.

7. The method of claim 1, further comprising:
identifying one or more characteristics of a writer of the sequence of words;
determining, based on the characteristics of the writer, an order in which the grammar corrector applies one or more of a plurality of error-based rules to determine if the sequence of words includes a grammatical error; and
applying the plurality of error-based rules based on the determined order.

8. The method of claim 7, wherein the characteristics of the writer of the sequence of words include a geographic region to which the writer belongs.

9. The method of claim 7, further comprising determining the characteristics of the writer by analyzing the sequence of words.

10. The method of claim 1, further comprising:
computing a score indicating a level of proficiency of a document in which the sequence of words are included based on a quantity of different error-based rules that matched the sequence of words; and
providing the computed score for display.

11. A system for detecting grammatical errors in a sequence of words using a set of error detection rules, the system comprises:
a grammar corrector comprising a memory and one or more processors, the grammar corrector configured to:
identify, by a grammatical checker configured on grammar corrector, word data representing a sequence of words to be analyzed for grammatical errors;
determine, by the grammatical checker, that each word of the sequence of words matches a word in a corpus represented by corpus data stored on the memory;
assign, by a third-party tagging system configured on the grammar corrector, one or more third-party tags to each of the words of the sequence of words, the grammar corrector storing, for each of the words, the one or more third-party tags assigned to the word with the word;
compare, by the grammatical checker, one or more of the words of the sequence of words to a predetermined list of words to be tagged using custom tags instead of third-party tags;
identify, by the grammatical checker, based on the comparison, a word of the sequence of words that is included in the predetermined list of words;
assign, by a first tagging system configured on the grammar corrector, a custom tag to the identified word, the grammar corrector storing the custom tag with the identified word;
generate, by the grammatical checker, a first sequence of tags including the custom tag and the one or more third-party tags, the sequence of tags arranged in the order of the words in the sequence of words;
identify, by the grammatical checker, an error-based rule that specifies a second sequence of tags representative of a grammatical error and corresponding third sequence of tags representative of a correction of the grammatical error of the second sequence of tags, the grammar corrector storing the second sequence of tags and the third sequence of tags;
determine, by the grammatical checker, that the first sequence of tags matches the second sequence of tags of the error-based rule;
responsive to determining that the first sequence of tags matches the second sequence of tags of the error-based rule, adjust the sequence of words to a revised sequence of words such that a revised sequence of tags based on the revised sequence of words matches the third sequence of tags; and
provide, for display, the revised sequence of words.

12. The system of claim 11, wherein the grammar corrector receives a document including the sequence of words to be analyzed for grammatical errors.

13. The system of claim 11, wherein the grammar corrector is further configured to:
determine, by the grammatical checker, that a misspelt word of the sequence of words does not match any word in the corpus;
determine, based on comparing characters of the misspelt word, that the misspelt word is similar to one or more words of the corpus;
identify tags associated with each of the one or more words of the corpus to which the misspelt word is similar;
assign the misspelt word a custom tag indicating that the word is misspelt; and
assign the misspelt word one or more tags based on the words of the corpus to which the misspelt word is similar.

14. The system of claim 11, wherein the custom tags assigned to the word that is included in the predetermined list of words are based on a combination of a part-of-speech tag, a singular or plural tag and a tense tag.

15. The system of claim 11, wherein the grammar corrector is further configured to:
identify, based on a comparison of the first sequence of tags and the third sequence of tags, a subset of tags of the first sequence of tags that are different from a corresponding subset of the third sequence of tags;
identify a subset of words of the sequence of words corresponding to the subset of tags; and
replace the subset of words with a revised subset of words from the corpus that when assigned tags, match the subset of the third sequence of tags.

16. The system of claim 15, wherein replacing the subset of words with a revised subset of words includes:
identifying the tags of the subset of the third sequence of tags;
identifying, from the corpus, words corresponding to the tags of the subset of the third sequence of tags as the revised subset of words.

17. The system of claim 11, wherein the grammar corrector is further configured to:
identify one or more characteristics of a writer of the sequence of words;
determine, based on the characteristics of the writer, an order in which the grammar corrector applies one or more of a plurality of error-based rules to determine if the sequence of words includes a grammatical error; and
apply the plurality of error-based rules based on the determined order.

18. The system of claim 17, wherein the characteristics of the writer of the sequence of words includes a geographic region to which the writer belongs.

19. The system of claim 17, wherein the grammar corrector determines the characteristics of the writer by analyzing the sequence of words.

20. The system of claim 11, wherein the grammar corrector is further configured to:
compute a score indicating a level of proficiency of a document in which the sequence of words are included based on a quantity of different error-based rules that matched the sequence of words; and
provide the computed score for display.
